(19) United States
(12) Patent Application Publication
(10) Pub. No.: US 2026/0343292 A1
(43) Pub. Date: Oct. 29, 2026

(54) PREDICTED INTERFERENCE REPORTING

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US)

(21) Appl. No.: 19/187,090

(22) Filed: Apr. 23, 2025

(51) Int. Cl. H04W 24/10; H04B 17/345

(52) U.S. Cl. CPC H04W 24/10; H04B 17/345

(57) ABSTRACT

Various aspects of the present disclosure generally relate to wireless communication. In some aspects, a network entity may receive configuration information that indicates a first set of one or more serving resources for measurement and a second set of one or more serving resources for prediction, the first set being associated with a third set of one or more interference resources for measurement, and the second set being associated with a fourth set of one or more interference resources for prediction. The network entity may perform one or more measurements to obtain interference measurement information associated with the third set of one or more interference resources. The network entity may obtain predicted interference information associated with the fourth set of one or more interference resources. The network entity may transmit a measurement report that indicates the predicted interference information. Numerous other aspects are described.

### FIELD OF THE DISCLOSURE

Aspects of the present disclosure generally relate to wireless communication and specifically relate to techniques, apparatuses, and methods associated with predicted interference reporting.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a network entity. The network entity may include a processing system. The processing system may be configured to receive configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The processing system may be configured to perform, based on the first set of one or more serving resources, one or more measurements to obtain interference measurement information associated with the third set of one or more interference resources. The processing system may be configured to obtain, based on the second set of one or more serving resources and the interference measurement information, predicted interference information associated with the fourth set of one or more interference resources. The processing system may be configured to transmit a measurement report that indicates the predicted interference information.

Some aspects described herein relate to a network entity. The network entity may include a processing system. The processing system may be configured to transmit configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The processing system may be configured to receive a measurement report that indicates predicted interference information that is based on interference measurement information, wherein the interference measurement information is associated with the first set of one or more serving resources and the third set of one or more interference resources, wherein the predicted interference information is associated with the second set of one or more serving resources and the fourth set of one or more interference resources.

Some aspects described herein relate to a method of wireless communication performed by a network entity. The method may include receiving configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The method may include performing, based on the first set of one or more serving resources, one or more measurements to obtain interference measurement information associated with the third set of one or more interference resources. The method may include obtaining, based on the second set of one or more serving resources and the interference measurement information, predicted interference information associated with the fourth set of one or more interference resources. The method may include transmitting a measurement report that indicates the predicted interference information.

Some aspects described herein relate to a method of wireless communication performed by a network entity. The method may include transmitting configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The method may include receiving a measurement report that indicates predicted interference information that is based on interference measurement information, wherein the interference measurement information is associated with the first set of one or more serving resources and the third set of one or more interference resources, wherein the predicted interference information is associated with the second set of one or more serving resources and the fourth set of one or more interference resources.

Some aspects described herein relate to an apparatus for wireless communication. The apparatus may include means for receiving configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The apparatus may include means for performing, based on the first set of one or more serving resources, one or more measurements to obtain interference measurement information associated with the third set of one or more interference resources. The apparatus may include means for obtaining, based on the second set of one or more serving resources and the interference measurement information, predicted interference information associated with the fourth set of one or more interference resources. The apparatus may include means for transmitting a measurement report that indicates the predicted interference information.

Some aspects described herein relate to an apparatus for wireless communication. The apparatus may include means for transmitting configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The apparatus may include means for receiving a measurement report that indicates predicted interference information that is based on interference measurement information, wherein the interference measurement information is associated with the first set of one or more serving resources and the third set of one or more interference resources, wherein the predicted interference information is associated with the second set of one or more serving resources and the fourth set of one or more interference resources.

Some aspects described herein relate to a non-transitory computer-readable medium having code stored thereon. The code, when executed by a network entity, may cause the network entity to receive configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The code, when executed by a network entity, may cause the network entity to perform, based on the first set of one or more serving resources, one or more measurements to obtain interference measurement information associated with the third set of one or more interference resources. The code, when executed by a network entity, may cause the network entity to obtain, based on the second set of one or more serving resources and the interference measurement information, predicted interference information associated with the fourth set of one or more interference resources. The code, when executed by a network entity, may cause the network entity to transmit a measurement report that indicates the predicted interference information.

Some aspects described herein relate to a non-transitory computer-readable medium having code stored thereon. The code, when executed by a network entity, may cause the network entity to transmit configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction. The code, when executed by a network entity, may cause the network entity to receive a measurement report that indicates predicted interference information that is based on interference measurement information, wherein the interference measurement information is associated with the first set of one or more serving resources and the third set of one or more interference resources, wherein the predicted interference information is associated with the second set of one or more serving resources and the fourth set of one or more interference resources.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIGS. 3A and 3B are diagrams illustrating a first example of multiple-input multiple output (MIMO) and a second example of multi-user MIMO (MU-MIMO).

FIG. 4 is a diagram illustrating an example artificial intelligence (AI) or AI/machine learning (AI/ML) model.

FIG. 5 is a diagram illustrating an example architecture of a functional framework for radio access network intelligence enabled by data collection.

FIG. 6 is a diagram illustrating an example of an AI/ML based beam management.

FIG. 7 is a diagram of an example associated with predicted interference reporting.

FIG. 8 is a diagram of an example associated with predicted interference reporting.

FIG. 9 is a diagram of an example associated with predicted interference reporting.

FIG. 10 is a diagram of an example associated with predicted interference reporting.

FIG. 11 is a diagram illustrating an example process performed, for example, at a network entity or an apparatus of a network entity.

FIG. 12 is a diagram illustrating an example process performed, for example, at a network entity or an apparatus of a network entity.

FIG. 13 is a diagram of an example apparatus for wireless communication.

FIG. 14 is a diagram of an example apparatus for wireless communication.

### DETAILED DESCRIPTION

Multi-user (MU) multiple-input multiple-output (MIMO) (MU-MIMO) technology may improve spectral efficiency by enabling a network node to communicate with multiple user equipments (UEs) using the same time and frequency resources, where the transmissions to the multiple UEs are spatially separated on different beams. The spatial separation enables simultaneous communication with the multiple UEs, thereby improving overall network capacity, or resource utilization efficiency, among other examples. However, the implementation of MU-MIMO may introduce interference, such as inter-user interference.

For example, MU-MIMO operation may present a risk of interference experienced by the multiple UEs. For example, because the network node may use the same time domain and frequency domain resources to communicate with multiple UEs, a first UE may experience interference (e.g., for a first transmission intended for the first UE via a first spatial domain resources or a first beam) that is caused by a second transmission from the network node that is intended for a second UE (e.g., where the second transmission uses second spatial domain resources or a second beam) when the first transmission and the second transmission use the same time domain and frequency domain resources. Such interference may be referred to as inter-user interference. In some examples, the network node may select or group UEs that the network node will communicate with using the same time domain and frequency domain resources for MU-MIMO operation. This may be referred to as UE pairing or UE grouping for MU-MIMO. For example, for paired or grouped UEs for MU-MIMO operation, the network node may ensure sufficient channel orthogonality (e.g., by ensuring sufficient beam separation between two or more beams used to communicate with the paired or grouped UEs) for the channels of respective UEs to reduce the MU-MIMO interference (e.g., the inter-user interference) at the UEs. For example, without sufficient channel orthogonality, the UEs may experience high interference, which may degrade performance (e.g., may degrade a block error rate (BLER), cause the UEs to use a less efficient modulation and coding scheme (MCS), or reduce spectral efficiency) for the UEs.

However, to ensure sufficient channel orthogonality, the UEs to be paired or grouped may perform a large quantity of interference measurements and report interference measurement information to the network node. Interference measurement for MU-MIMO operation may be associated with a larger quantity of interference measurements as compared to other operations (such as a single user (SU)-MIMO operation) because a given UE may perform measurements for multiple downlink serving beams and for multiple interfering beams. An interfering beam for a first UE may be a beam that the network node may use as a downlink serving beam for a second UE (e.g., where the first UE and the second UE are candidates to be paired or grouped for MU-MIMO operation). For example, for MU-MIMO operation, the UE may set one or more receive parameters (such as a receive filter, among other examples) based on a configuration of a downlink serving beam. The UE may measure interference received via a second beam, such as an interfering beam (e.g., where the interference is measured with the UE using the one or more receive parameters that are based on the configuration of the downlink serving beam). This enables the UE to obtain interference measurement information for the interfering beam if the UE were to use the downlink serving beam for downlink communication with the network node. The interference measurement information enables the network node to evaluate a level of interference that would be caused for the UE if the network node were to use the downlink serving beam to serve the UE and were to use the interfering beam to serve a different UE in a MU-MIMO operation.

As a result, to enable the network node to obtain interference measurement information for all the combinations for downlink serving beams for two or more UEs, a measurement overhead for the two or more UEs may be high. Performing the high quantity of interference measurements increases configuration signaling overhead (e.g., associated with the network node configuring the UE to perform the large quantity of interference measurements), or increases processing or energy overhead (e.g., associated with the UE performing the large quantity of interference measurements). This measurement overhead may increase as network nodes support higher quantities of beams (e.g., more than 64 beams) in advanced wireless communication systems, such as 6G systems and beyond.

In some examples, to reduce the measurement overhead, the network node may configure the UE to perform MU-MIMO interference measurements using a single downlink serving beam (or a small quantity of downlink serving beams, such as two, three, or four downlink serving beams) and a single interfering beam (or a small quantity of interfering beams, such as two, three, or four interfering beams). This reduces the measurement overhead associated with enabling MU-MIMO operation. However, this also reduces the amount of interference measurement information available to the network node when determining which UEs should be paired or grouped for MU-MIMO operation. Because the network node may use reduced or partial interference measurement information to group or pair UEs for MU-MIMO operation, there may be an increased risk of the MU-MIMO operation resulting in high interference levels for the UEs (e.g., caused by a suboptimal grouping or pairing determined by the network node).

Various aspects relate generally to a predicted interference reporting. Some aspects more specifically relate to a predicted interference report than enables enhanced or efficient pairing or grouping of network entities for MU-MIMO operation. In some aspects, a first network entity may transmit, and a second network entity may receive, configuration information that indicates serving resources for measurement and prediction, as well as associated interference resources. Based on the configuration information, the second network entity may perform one or more measurements to obtain interference measurement information. The second network entity may use these interference measurement information to predict interference for the serving resource(s) and interference resource(s) that are configured for prediction. The second network entity may transmit, and the first network entity may receive, a measurement report that includes the predicted interference information.

In the context of the resource(s) for measurement or prediction, a “resource” (e.g., a serving resource or an interfering resource) may indicate spatial direction information or one or more transmission parameters. For example, the resource may be a spatial direction resource, a beam resource, or a reference signal resource, among other examples. In some aspects, the resource may be a channel state information (CSI) reference signal (CSI-RS) resource. A “serving” resource refers to a resource that is configured for communication for the second network entity (e.g., a serving resource may be a resource via which the second network entity is to transmit or receive communications, or be served via, in association with the second network entity). An “interference” resource refer to a resource via which interference may be introduced for the second network entity. For example, an interference resource may be a candidate serving resource for a third network entity, where the second network entity and the third network entity are candidates to be paired or grouped for MU-MIMO operation.

In some aspects, the serving resources for measurement and prediction may be the same, while the interference resources for measurement and prediction may differ.

Alternatively, the serving resources for measurement and prediction can be different sets, and the respective interference resources may also differ or overlap. The network entity may perform interference measurements during specific time occasions and use these measurements to predict interference for future time occasions. Similarly, measurements may be performed over certain frequency resources, with predictions made for different frequency resources. The predicted interference information may indicate a predicted interference power, a predicted interference covariance matrix, or a predicted signal-to-interference-plus-noise ratio (SINR), among other examples.

Particular aspects of the subject matter described in this disclosure can be implemented to realize one or more of the following advantages. By the second network entity predicting interference using the serving resources and the interference resources for prediction (e.g., based on the interference measurement information obtained via the serving resources and the interference resources for measurement), the described techniques may reduce the quantity of interferences measurements performed by the second network entity, thereby reducing signaling overhead, or processing resources using to perform the interference measurements. Additionally, by the first network entity configuring one or more serving resources for measurement, one or more serving resources for prediction, one or more interference resources for measurement, and one or more interference measurements for prediction, the second network entity may transmit, and the first network entity may receive, predicted interference that is more indicative of interference that may be experienced during MU-MIMO operation. This enables the first network to make more informed pairing or grouping determinations for the MU-MIMO operation, which may result in improved spectral efficiency, or reduced interference, among other examples, for the MU-MIMO operation.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

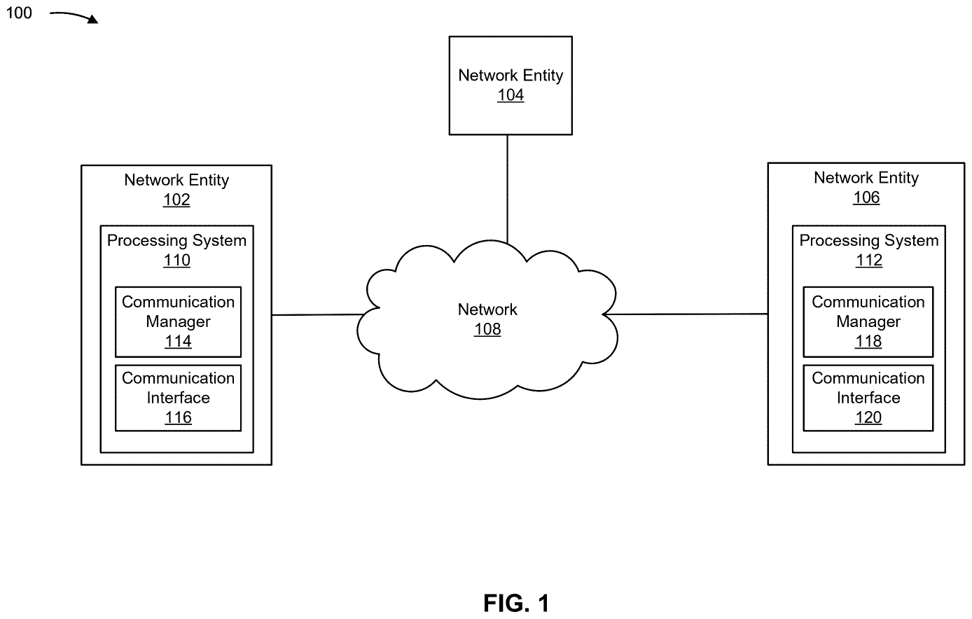

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

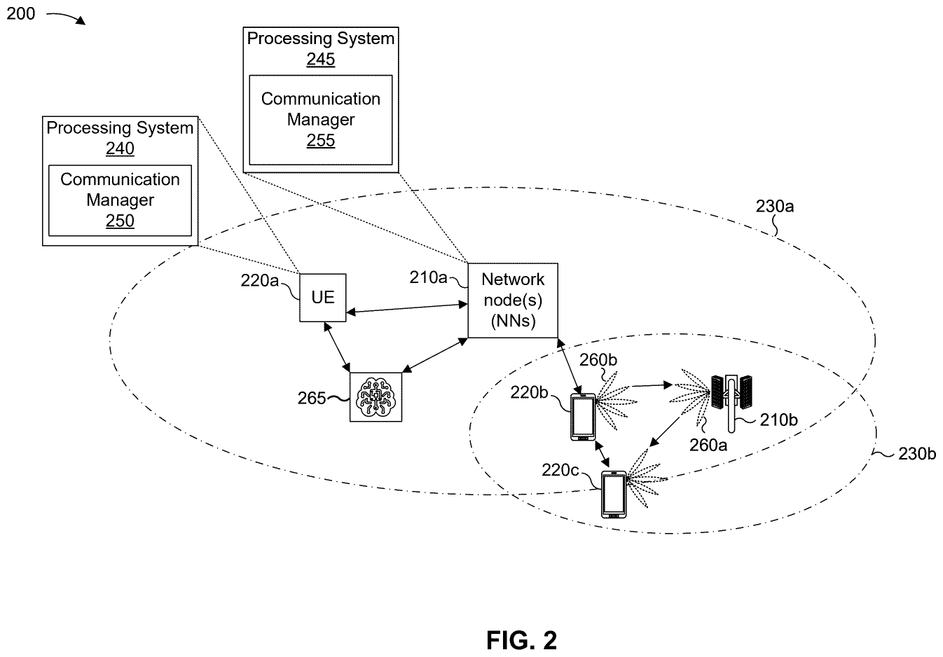

The network 108 may include, for example, a cellular network (e.g., a Long-Term Evolution (LTE) network, a CDMA network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 or the communication interface 116 to) receive configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; perform one or more measurements to obtain interference measurement information associated with the third set of one or more interference resources; obtain predicted interference information associated with the fourth set of one or more interference resources; or transmit a measurement report that indicates the predicted interference information. Additionally, or alternatively, the network entity 102 or the communication manager 114 may perform one or more other operations described herein.

As described in more detail elsewhere herein, the network entity 106 may (e.g., the processing system 112 may, or the processing system 112 may cause the communication manager 118 or the communication interface 120 to) transmit configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; or receive a measurement report that indicates predicted interference information that is based on interference measurement information, wherein the interference measurement information is associated with the first set of one or more serving resources and the third set of one or more interference resources, wherein the predicted interference information is associated with the second set of one or more serving resources and the fourth set of one or more interference resources. Additionally, or alternatively, the network entity 106 or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a and a network node 210b (each of which also may be referred to herein simply as a “network node 210”). The network nodes 210 may support communications with multiple UEs 220. For example, in FIG. 2, the network nodes 210 support communication with a UE 220a, a UE 220b, and a UE 220c (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an IAB network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active BWP defines the operating bandwidth of the UE 220 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 220a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 220a. Non-codebook-based precoding may involve selecting or deriving a precoder based on, or otherwise associated with, one or more downlink or uplink signal measurements. The network node 210a or the UE 220a may transmit the processed downlink or uplink signals, respectively, via one or more antennas.

The network node 210a or the UE 220a may receive uplink signals or downlink signals, respectively, via one or more antennas. The network node 210a or the UE 220a (for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210a or the UE 220a (for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or MU-MIMO, the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 260a, and a UE 220 may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Single-input-single-output (SISO) systems and multiple-input-multiple-output (MIMO) systems are two approaches to wireless communications. The use of a SISO system versus a MIMO system may depend on a variety of operating factors, such as requested data rates, data transfer latency operating conditions, implementation costs, or network access demand, among other examples. A SISO system may provide a cost-effective solution for areas that have low network access demand, while a MIMO system may provide higher data throughput or lower data transfer latencies relative to a SISO system.

In a SISO system, a transmitter device (for example, a network node 210) includes a first (single) antenna that is used to transmit a wireless signal, and a receiver device (for example, a UE 220) includes a second (single) antenna to receive the wireless signal. In a MIMO system, a transmitter device and a receiver device wirelessly communicate with one another using, for example, multiple antennas. For example, the transmitter device may include M antennas and the receiver device may include N antennas.

The demand for services provided by a wireless network continues to increase as more devices access wireless communication networks. A MIMO system may, in some cases, meet the demand based on the ability to simultaneously or contemporaneously transmit multiple data streams. For example, the use of multiple antennas in a MIMO system allows a transmitter device to simultaneously or contemporaneously transmit the multiple data streams using different paths (for example, different spatial paths or different polarization paths), resulting in increased data throughput based at least in part on transmitting multiple data streams using diverse signals.

MU)-MIMO can be used to provide MIMO access to multiple UEs simultaneously or contemporaneously in the same communication system (for example, the wireless communication network 200). In MU-MIMO, a network node 210 may serve multiple UEs 220 may be served simultaneously by a network node 210 based on beamforming, spatial diversity, or polarization diversity, among other examples. For example, a network node 210 may transmit first UE data to a first UE 220 using a first beam, second UE data to a second UE 220 using a second beam, and third UE data to a third UE 220 using a third beam. The network node 210 may form the first beam by applying first precoding to multiple signals that, when summed together, form the first beam. In a similar manner, the network node 210 may form the second beam and the third beam. The multiple signals that form the first beam, the multiple signals that form the second beam, and the multiple signals that form the third beam may be simultaneously emitted by one or more of the multiple antennas of the network node 210.

MU-MIMO enables a transmitting device (for example, the network node 210) to use a single antenna array to serve multiple users (for example, multiple UEs 220) by spatially multiplexing their data streams across distinct beams. In some examples, the transmitting device (for example, the network node 210) may use large antenna arrays (for example, with a large quantity of antenna elements) to enable the transmitted device to communicate with a large quantity of users (for example, multiple UEs 220) simultaneously. For example, the large quantity of antenna elements may enable the transmitting device to form an increased quantity of beams simultaneously using the same antenna array or antenna panel. Additionally, the use of AI/ML techniques may enable the transmitting device to perform improved or more efficient beamforming, thereby enabling dynamic or intelligent allocation of beams for respective users, optimizing how users are served based on real-time data, mobility, or network conditions. MU-MIMO may enable improved scalability, reduced latency, or the ability to support high-density networks, among other examples. As a result, MU-MIMO may enable applications or use cases, such as autonomous systems, XR applications, or large-scale IoT deployments, among other examples.

In some examples, to support these and other applications and use cases, the wireless communication network 200 may support full-duplex MIMO, enhanced uplink and downlink MIMO, continued MIMO, or cell-free MIMO, among other examples. Full-duplex MIMO may enable a network node 210 or a UE 220 to use a shared antenna array for transmission and reception in a MIMO system. The large quantity of antennas used in the MIMO system may enable the network node 210 or the UE 220 to minimize self-interference, intra-cell interference, or inter-cell interference in full-duplex operation because of the ability to narrow and focus radiated energy toward an intended recipient using the large quantity of antennas. In some examples, to enable increased capacity, a MIMO system may operate at higher frequency bands, such as frequency bands above 7 GHz. To support MIMO operation using the higher frequency bands, a network node 210 may include a dense antenna array (such as a 4,096 antenna element antenna array) to achieve higher beamforming gains, thereby improving performance of transmitted signals using the higher frequency bands which may be associated with higher path loss or increased sensitivity to interference. The MIMO operation using the higher frequency bands (e.g., using the dense antenna array) may sometime be referred to as gigantic (giga) MIMO. In some examples, a network node 210 may support lensed MIMO in which the network node 210 performs beamforming using a lens to focus RF energy in a narrow or precise beam to support MIMO operation in higher frequency bands, such as a sub-terahertz frequency band.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a network entity (e.g., the UE 220) may include a communication manager 250. As described in more detail elsewhere herein, the communication manager 250 may receive configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; perform one or more measurements to obtain interference measurement information associated with the third set of one or more interference resources; obtain predicted interference information associated with the fourth set of one or more interference resources; and transmit a measurement report that indicates the predicted interference information. Additionally, or alternatively, the communication manager 250 may perform one or more other operations described herein.

In some aspects, a network entity (e.g., the network node 210) may include a communication manager 255. As described in more detail elsewhere herein, the communication manager 255 may transmit configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; and receive a measurement report that indicates predicted interference information, wherein the interference measurement information is associated with the first set of one or more serving resources and the third set of one or more interference resources, wherein the predicted interference information is associated with the second set of one or more serving resources and the fourth set of one or more interference resources, and wherein the predicted interference information is based on the interference measurement information. Additionally, or alternatively, the communication manager 255 may perform one or more other operations described herein.

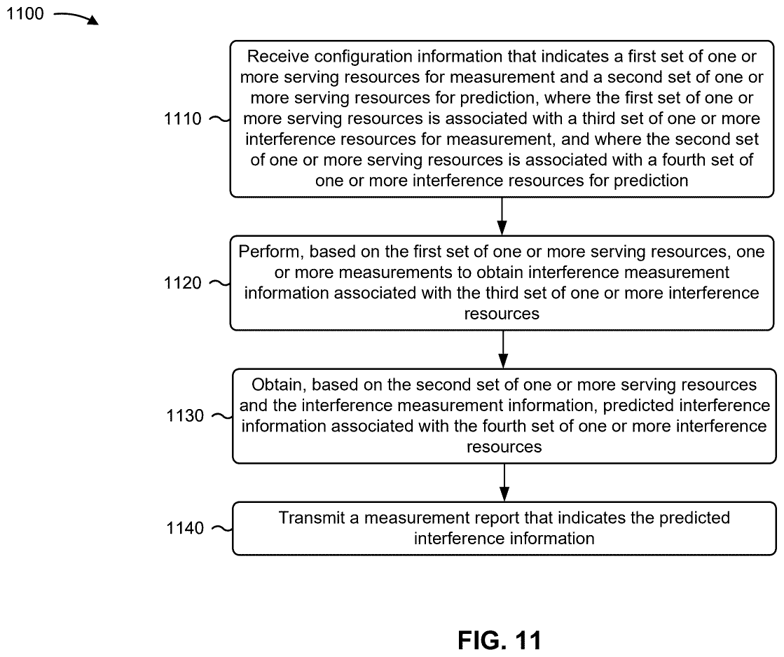

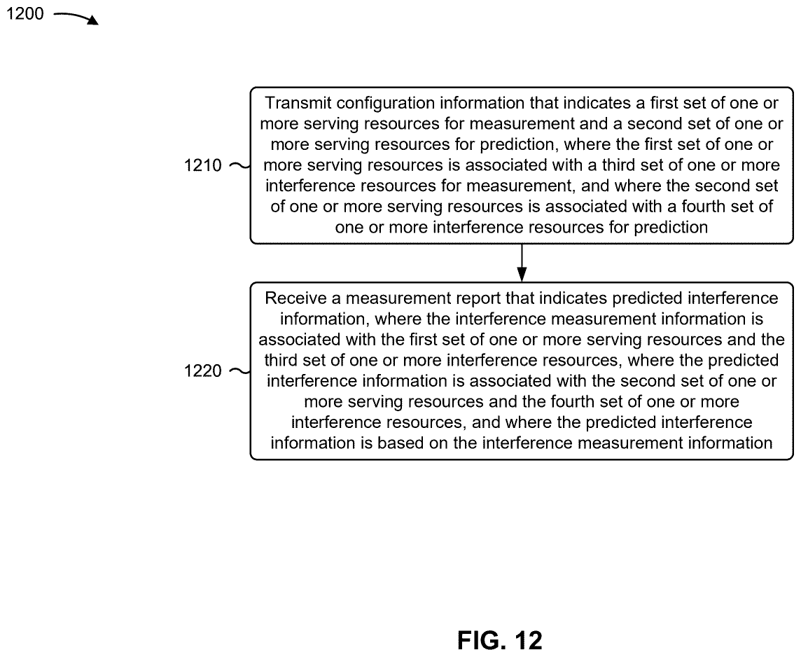

The network entity 102, the processing system 110 of the network entity 102, the network entity 106, the processing system 112 of the network entity 106, the network node 210, the processing system 245 of the network node 210, the UE 220, the processing system 240 of the UE 220, or any other component(s) of FIGS. 1-2 may implement one or more techniques or perform one or more operations associated with predicted interference reporting, as described in more detail elsewhere herein. For example, the processing system 110 of the network entity 102, the processing system 112 of the network entity 106, the processing system 245 of the network node 210, or the processing system 240 of the UE 220 may perform or direct operations of, for example, process 1100 of FIG. 11, process 1200 of FIG. 12, or other processes as described herein (alone or in conjunction with one or more other processors). Memory of the network node 210 may store data and program code (or instructions) for the network node 210. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, or the UE 220 may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

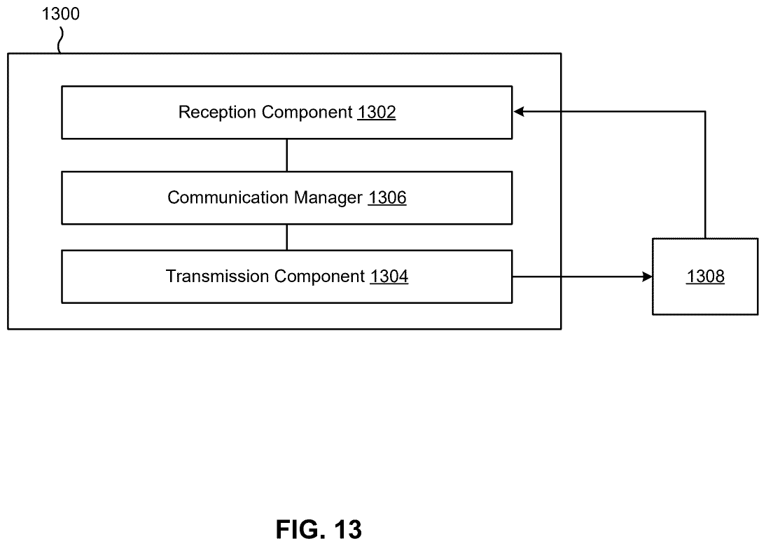

In some aspects, a network entity includes means for receiving configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; means for performing, based on the first set of one or more serving resources, one or more measurements to obtain interference measurement information associated with the third set of one or more interference resources; means for obtaining, based on the second set of one or more serving resources and the interference measurement information, predicted interference information associated with the fourth set of one or more interference resources; or means for transmitting a measurement report that indicates the predicted interference information. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1302 depicted and described in connection with FIG. 13) or a transmission component (for example, transmission component 1304 depicted and described in connection with FIG. 13), among other examples.

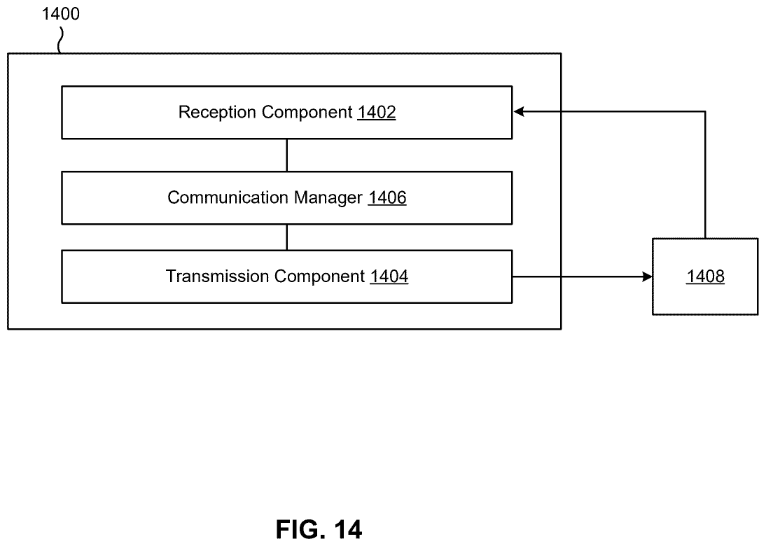

In some aspects, the includes means for transmitting configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; or means for receiving a measurement report that indicates predicted interference information, wherein the interference measurement information is associated with the first set of one or more serving resources and the third set of one or more interference resources, wherein the predicted interference information is associated with the second set of one or more serving resources and the fourth set of one or more interference resources, and wherein the predicted interference information is based on the interference measurement information. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

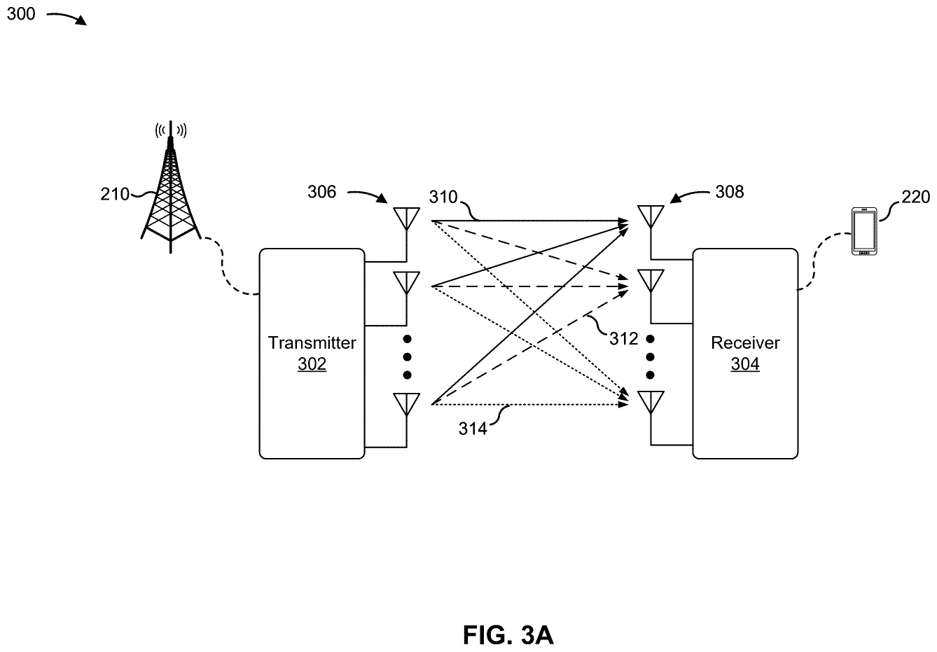

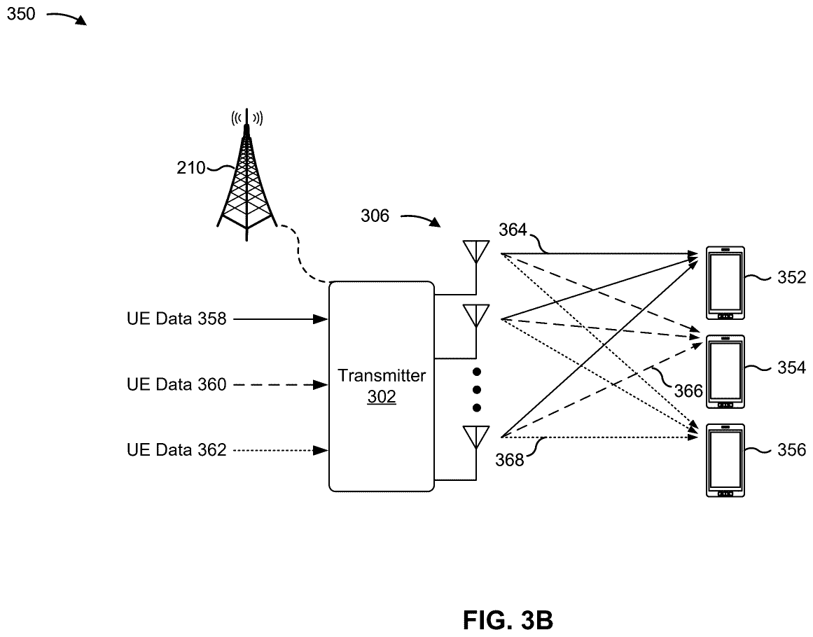

FIGS. 3A and 3B are diagrams illustrating a first example 300 of MIMO and a second example 350 of MU-MIMO.

The first example 300 shown by FIG. 3A is an example MIMO system that includes a transmitter device 302 (shown by FIG. 3A as being a network node 210) and a receiver device 304 (shown by FIG. 3A as being a UE 220). In the MIMO system, the transmitter device 302 and the receiver device 304 wirelessly communicate with one another based at least in part on multiple antennas. To illustrate, the transmitter device 302 may include M antennas as shown by reference number 306, and the receiver device 304 may include N antennas as shown by reference number 308, where M and N are integers that may be equal or different from one another (e.g., M=N, M>N, or M<N).

In some aspects, the transmitter device 302 may transmit multiple data streams via the M antennas based at least in part on using signal diversity, such as spatial diversity or polarization diversity. Typically, the number of data streams transmitted by a transmitter device is fewer than a number of antennas. That is, the mapping of the number of data streams to the number of antennas is not 1:1. Rather, each stream may be mapped with a unique set of weights to all of the available antenna such that all of the available antennas are used to transmit the multiple data streams. To illustrate, the transmitter device 302 may transmit a first data stream 310 (shown with a solid line) using all of the M antennas and a first set of precoding weights. Accordingly, each antenna of the M antenna may transmit a respective signal that carries the first data stream, and the respective signal may be precoded using a particular weight in the first set of precoding weights. Alternatively, or additionally, the transmitter device 302 may transmit a second data stream 312 (shown with a dashed line) using all of the M antennas and a second set of precoding weights, or a third data stream 314 (shown with a dotted line) using all of the M antennas and a third set of precoding weights. Other examples may include the transmitter device 302 transmitting each data stream using a respective subset of antennas of the M antennas. “Analog beamforming” may denote signal manipulation (e.g., the application of precoding weights) in an analog domain or an RF domain, and “digital beamforming” may denote signal manipulation in a digital domain. A transmitter device (e.g., the transmitter device 302) may perform beamforming using analog beamforming, digital beamforming, or a combination of analog beamforming and digital beamforming. “Spatial diversity” may denote spatially diverse signal transmissions. To illustrate, and as described above, the transmitter device 302 may apply precoding to multiple signals that, when summed together, form a first beam at a first carrier frequency, where the first beam propagates in a first direction with a first spatial beamwidth. For example, the precoding may adjust respective phases or amplitudes of two or more signals that are transmitted by two or more antennas to constructively form the first beam, and the first beam may carry a first data stream. Alternatively, or additionally, the transmitter device 302 may apply precoding to multiple signals that, when summed together, form a second beam at a second carrier frequency (e.g., that may be the same carrier frequency as the first carrier frequency or a different carrier frequency from the first carrier frequency) that propagates in a second direction with a second spatial beamwidth. In some aspects, the second beam may carry a second data stream that is different from the first data stream. The transmitter device 302 may select the second propagation direction or the second spatial beamwidth to mitigate or avoid overlap with the first propagation direction or the first spatial beamwidth. That is, the first beam and the second beam may be spatially diverse based at least in part on propagating in non-overlapping directions with non-overlapping spatial beamwidths (or partially overlapping directions or spatial beamwidths). “Polarization diversity” may denote at least two signals that have diverse polarizations. As one example, an electromagnetic (EM) wave may include an electric field (E-field) and magnetic field (H-field) that propagate along a same propagation line (e.g., a same direction) and are perpendicular to one another. For example, in an XYZ coordinate system that is characterized by an X-plane, a Y-plane, and a Z-plane that are perpendicular to one another, the E-field of the EM wave is separated from the H-field by 90 degrees. Accordingly, if an E-field that propagates along an X-axis with an amplitude that varies along the Y-axis (e.g., within a horizontal X-Y plane), the H-field may also propagate along the X-axis with an amplitude that varies along the Z-axis (e.g., in a perpendicular, vertical X-Z plane). In linear polarization, the E-field and the H-field may propagate without rotating around the propagation line, while in circular polarization, the E-field and the H-field may rotate around the propagation line. In some examples, the transmitter device 302 may transmit a first signal that is based at least in part on a first carrier frequency and a first polarization. Alternatively, or additionally, the transmitter device 302 may transmit a second signal that is based at least in part on a second carrier frequency (e.g., that may be the same carrier frequency as the first carrier frequency or a different carrier frequency from the first carrier frequency) and a second polarization that is orthogonal to the first polarization. That is, the first signal and the second signal may have diverse polarizations. For example, the E-field of the first signal is orthogonal to the E-field of the second signal, and the H-field of the first signal is orthogonal to the H-field of the second signal. In some examples, the first signal may carry first data, and the second signal may carry second data that is different from the first data. To illustrate, the transmitter device 302 may include at least a first antenna that is configured to generate a first signal that has a first polarization and a second antenna that is configured to generate a second signal that has a second polarization.

While the above example describes polarization with respect to orthogonal E-fields and orthogonal H-fields, other examples may use polarizations that are sufficiently decorrelated. For instance, two polarizations may be a complex weighted combination of E-field and H-field polarizations. As another example, the two polarizations may be based at least in part on a polarization distribution of the antenna elements in an antenna array. With enough decorrelation between polarizations, same or different spatial directions (e.g., transmit antenna weights), and same or different frequencies may be used for two transmission paths.

The demand for services provided by a wireless network continues to increase as more and more devices access the wireless network. A MIMO system may, in some cases, meet the demand based at least in part on the ability to simultaneously or contemporaneously transmit multiple data streams. To illustrate, and as described above, the use of multiple antennas in a MIMO system allows a transmitter device to simultaneously or contemporaneously transmit the multiple data streams using different paths (e.g., different spatial paths or different polarization paths), resulting in increased data throughput based at least in part on transmitting multiple data streams using diverse signals.

The second example 350 shown by FIG. 3B is an example of MU-MIMO in which the transmitter device 302 (e.g., the network node 210) simultaneously serves multiple UEs (shown in FIG. 3B as a first UE 352, a second UE 354, and a third UE 356) based at least in part on beamforming, spatial diversity (e.g., spatial multiplexing), or polarization diversity (e.g., polar multiplexing). For example, the transmitter device 302 may simultaneously serve a first UE 352, a second UE 354, and a third UE 356 using MU-MIMO communications. To illustrate, the transmitter device 302 may transmit first UE data 358 (shown with a solid line) that is associated with the first UE 352 using a first beam, second UE data 360 (shown with a dashed line) that is associated with the second UE 354 using a second beam, and third UE data 362 (shown with a dotted line) that is associated with the third UE 356 using a third beam. As shown by reference number 364, the transmitter device 302 may form the first beam by applying first precoding to multiple signals (illustrated by FIG. 3B with solid lines) that, when summed together, form the first beam. In a similar manner, as shown by reference number 366, the transmitter device 302 may form the second beam by applying second precoding to multiple signals (illustrated by FIG. 3B with dashed lines), and may form the third beam by applying third precoding to multiple signals (illustrated by FIG. 3B with dotted lines) as shown by reference number 368. The multiple signals that form the first beam, the multiple signals that form the second beam, and the multiple signals that form the third beam may be simultaneously emitted by one or more of the multiple antennas shown by reference number 306. The first beam, the second beam, and the third beam may use different carrier frequencies, may use a same carrier frequency, may use different air interface resources, or may use a same air interface resource. The first UE 352, the second UE 354, and the third UE 356 may include, respectively, a single antenna port or multiple antenna ports, and each antenna port may be associated with one or more antennas of the respective UE. The simultaneous transmissions to respective devices (e.g., UEs in the second example 350) may alternatively be referred to as MU-MIMO communications.

A network node may select or group UEs for MU-MIMO communications in a same time partition (e.g., a slot) based at least in part on a variety of factors that may affect MU-MIMO performance (e.g., increase or decrease data throughput). For instance, the network node may select UEs based at least in part on UE location or beams that are used to communicate with the UEs. To illustrate, the network node may select or group UEs that are associated with different beams, beams that have low correlation, or beams that have high spatial diversity. As another example, the network node may select or group UEs based at least in part on one or more signal quality metrics, such as by grouping UEs that are associated with CQI metrics that satisfy a CQI threshold or UEs that are associated with SRS SINR metrics that satisfy an SRS SINR threshold. Alternatively, or additionally, the network node may enable or disable MU-MIMO communications based on a variety of factors that affect MU-MIMO performance, such as a number of UEs served by the network node, a traffic load of the network node, a scatter distribution in a cell provided by the network node, or a UE distribution (e.g., location distribution) in the cell provided by the network node. MU-MIMO operation may provide improved spectral efficiency by enabling a network node 210 to communicate (e.g., to serve) multiple UEs (e.g., using different spatial domain resources or beams) using the same time domain and frequency domain resources. MU-MIMO operation may be performed for both downlink and uplink communications (e.g., a network node 210 may transmit or receive communications on respective beams from multiple UEs using the same time domain and frequency domain resources).

In some cases, MU-MIMO operation may present a risk of interference experienced by the receivers (e.g., by the multiple UEs). For example, because the network node 210 may use the same time domain and frequency domain resources to communicate with multiple UEs 220, a first UE 220 may experience interference (e.g., for a first transmission intended for the first UE 220 via a first spatial domain resources or a first beam) that is caused by a second transmission from the network node 210 that is intended for a second UE 220 (e.g., where the second transmission uses second spatial domain resources or a second beam) when the first transmission and the second transmission use the same time domain and frequency domain resources. Such interference may be referred to as inter-user interference. As described above, the network node 210 may select or group UEs that the network node 210 will communicate with using the same time domain and frequency domain resources. This may be referred to as UE pairing or UE grouping for MU-MIMO. For example, for paired or grouped UEs for MU-MIMO operation, the network node 210 may ensure sufficient channel orthogonality (e.g., by ensuring sufficient beam separation between two or more beams used to communicate with the paired or grouped UEs) for the channels of respective UEs to reduce the MU-MIMO interference (e.g., the inter-user interference) at the UEs. For example, without sufficient channel orthogonality, the UEs may experience high MU-MIMO interference, which may degrade performance (e.g., may degrade a block error rate (BLER), cause the UEs to use a less efficient MCS, or reduce spectral efficiency) for the UEs.

However, to ensure sufficient channel orthogonality, the UEs to be paired or grouped may perform a large quantity of interference measurements and report interference measurement information to the network node 210. Interference measurement for MU-MIMO operation may be associated with a larger quantity of interference measurements as compared to other operations (such as a SU-MIMO operation depicted in FIG. 3A) because a given UE may perform measurements for multiple downlink serving beams and for multiple interfering beams. An interfering beam for a first UE may be a beam that the network node may use as a downlink serving beam for a second UE (e.g., where the first UE and the second UE are candidates to be paired or grouped for MU-MIMO operation). For example, for MU-MIMO operation, the UE may set one or more receive parameters (such as a receive filter, among other examples) based on a configuration of a downlink serving beam. The UE may measure interference received via a second beam, such as an interfering beam (e.g., where the interference is measured with the UE using the one or more receive parameters that are based on the configuration of the downlink serving beam). This enables the UE to obtain interference measurement information for the interfering beam if the UE were to use the downlink serving beam for downlink communication with the network node 210. The interference measurement information enables the network node 210 to evaluate a level of interference that would be caused for the UE if the network node 210 were to use the downlink serving beam to serve the UE and were to use the interfering beam to serve a different UE in a MU-MIMO operation.

As a result, to enable the network node 210 to obtain interference measurement information for all the combinations for downlink serving beams for two or more UEs, a measurement overhead for the two or more UEs may be high. As an example, the network node 210 may be configured to (or capable of) transmitting or receiving using 64 different beams (e.g., 64 CSI-RS beams, where each CSI-RS beam is mapped to, or associated with, a given CSI-RS resource). To enable the network node 210 to determine an optimal pairing or grouping of UEs for MU-MIMO operation, the network node 210 may configure two or more UEs to measure each combination of serving and interfering beams from the 64 different beams. This may result in a given UE performing 4,032 interference measurements (e.g., a permutation of two beams from the 64 different beams is 64×63=4,032). Performing this quantity of interference measurements increases configuration signaling overhead (e.g., associated with the network node 210 configuring the UE to perform the large quantity of interference measurements), or increases processing or energy overhead (e.g., associated with the UE performing the large quantity of interference measurements). This measurement overhead may increase as network nodes support higher quantities of beams (e.g., more than 64 beams) in advanced wireless communication systems, such as 6G systems and beyond.

In some examples, to reduce the measurement overhead, the network node 210 may configure the UE to perform MU-MIMO interference measurements using a single downlink serving beam (or a small quantity of downlink serving beams, such as two, three, or four downlink serving beams) and a single interfering beam (or a small quantity of interfering beams, such as two, three, or four interfering beams). This reduces the measurement overhead associated with enabling MU-MIMO operation. However, this also reduces the amount of interference measurement information available to the network node 210 when determining which UEs should be paired or grouped for MU-MIMO operation. Because the network node 210 may use reduced or partial interference measurement information to group or pair UEs for MU-MIMO operation, there may be an increased risk of the MU-MIMO operation resulting in high interference levels for the UEs (e.g., caused by a suboptimal grouping or pairing determined by the network node 210).

As indicated above, FIGS. 3A and 3B are provided as examples. Other examples may differ from what is described with regard to FIGS. 3A and 3B.

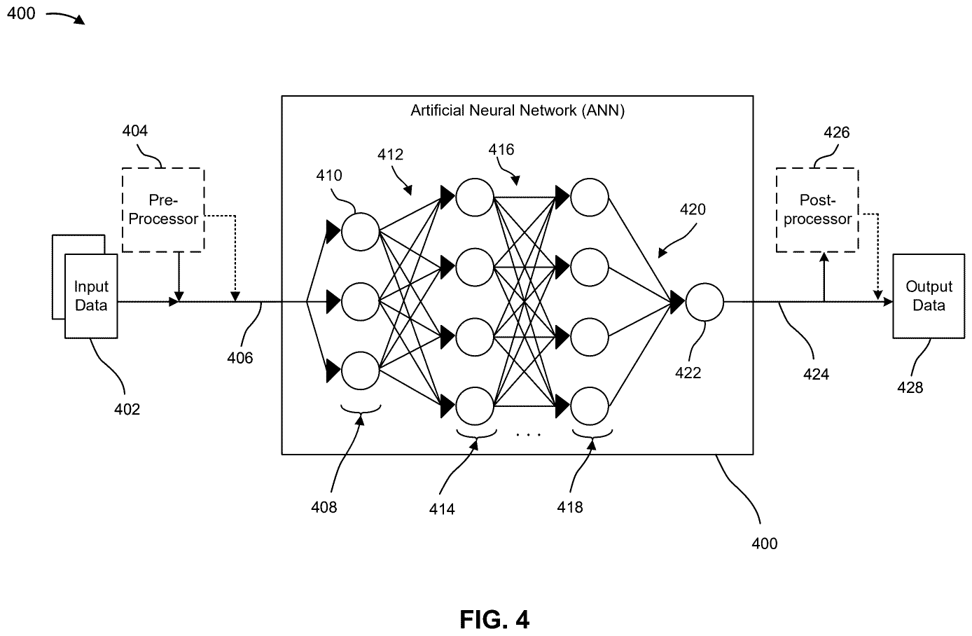

FIG. 4 is a diagram illustrating an example artificial intelligence or AI/ML model. The artificial intelligence or AI/ML model is represented in FIG. 4 as an ANN 400.

As shown in FIG. 4, the ANN 400 may receive input data 406, which may include one or more bits of data 402, pre-processed data output from pre-processor 404 (which is optional), or some combination thereof. Here, the bits of data 402 may include training data, verification data, application-related data, or the like, based, for example, on the stage of deployment of ANN 400. In some examples, the pre-processor 404 may be included within the ANN 400. The pre-processor 404 may, for example, process all or a portion of data 402, which may result in some of data 402 being changed, replaced, or deleted, among other examples. In some aspects, the pre-processor 404 may add additional data to data 402. In some aspects, the pre-processor 404 may be an AI/ML model, such as an ANN.

As shown in FIG. 4, the ANN 400 includes at least one first layer 408 of artificial neurons 410 to process input data 406 and provide resulting first layer data via connections or “edges” such as edges 412 to at least a portion of at least one second layer 414. The second layer 414 processes data received via edges 412 and provides second layer output data via edges 416 to at least a portion of at least one third layer 418. The third layer 418 processes data received via edges 416 and provides third layer output data via edges 420 to at least a portion of a final layer 422 including one or more neurons to provide output data 424. All or part of output data 424 may be further processed in some manner by (optional) post-processor 426. Thus, in certain examples, the ANN 400 may provide output data 428 that is based on output data 424, post-processed data output from post-processor 426, or some combination thereof.

The post-processor 426 may be included within the ANN 400 in some examples. The post-processor 426 may, for example, process all or a portion of output data 424, which may result in output data 428 being different, at least in part, to output data 424, as result of data being changed, replaced, or deleted, among other examples. In some examples, post-processor 426 may be configured to add additional data to output data 424. In this example, the second layer 414 and the third layer 418 represent intermediate or hidden layers that may be arranged in a hierarchical or other like structure. Although not explicitly shown in FIG. 4, there may be one or more further intermediate layers between the second layer 414 and the third layer 418. In some examples, the post-processor 426 may be an AI/ML model, such as an ANN.

The structure and training of artificial neurons 410 in the various layers may be tailored to specific requirements of an application. Within a given layer such as first layer 408, second layer 414, or third layer 418 of the ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 400. The weights and biases of the ANN 400 may be adjusted during a training process or during operation of the ANN 400. The weights of the various artificial neurons may control a strength of connections between layers or artificial neurons, while the biases may control a direction of connections between the layers or artificial neurons. An activation function may select or determine whether an artificial neuron transmits an output to the next layer in response to received data.

Different activation functions may be used to model different types of non-linear relationships. By introducing non-linearity into an AI/ML model, an activation function allows the configuration for the AI/ML model to change in response to identifying or detecting complex patterns and relationships in the input data 406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an AI/ML model, such as ANN 400, may be conducted using training data. Training data may include one or more datasets that the ANN 400 may use to identify patterns or relationships. Training data may represent various types of information, including written, visual, audio, environmental context, or operational properties, among other examples. During training, the parameters (such as the weights and biases) of artificial neurons 410 may be changed, such as to minimize or otherwise reduce a loss function or a cost function. A training process may be repeated multiple times to fine-tune the ANN 400 with each iteration.

Various ANN model structures are available for consideration. For example, the ANN 400 may implement or may be implemented in a feedforward ANN structure, a convolutional ANN structure, a recurrent ANN structure, an autoencoder ANN structure, a generative adversarial ANN structure, or a transformer ANN structure. Another example ANN structure is an AI/ML model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks, among others.

The ANN 400 or other AI/ML models may be implemented in various types of processing circuits along with memory and applicable instructions therein. For example, general-purpose hardware circuits, such as, such as one or more CPUs, one or more GPUs, or suitable combinations thereof, may be employed to implement a model. In some implementations, one or more tensor processing units (TPUs), NPUs, or other special-purpose processors, field-programmable gate arrays (FPGAs), ASICs, or the like may also be employed. In some implementations, the AI/ML model may be implemented by a processing system, such as the processing system 110, the processing system 112, the processing system 240, or the processing system 245. In some implementations, the AI/ML model may be implemented by a NPU or a TPU embedded in an SoC along with other components, such as one or more CPUs, GPUs, or the like. An SoC includes several components manufactured on a shared semiconductor substrate. The NPU or TPU may be controlled by the one or more CPUs by configuring the AI/ML model implemented by the NPU or TPU with weights and biases, providing certain training data to the AI/ML model to configure the AI/ML model, or providing input data to the AI/ML model to obtain related inferences. The one or more CPUs may also receive the inferences and be configured to perform certain actions based on the inferences produced by the AI/ML model. The actions performed by the one or more CPUs may include sending commands to other components of the SoC or components external to the SoC to perform certain actions. For example, the CPU may send commands to an RF transceiver based on the outputs or inferences obtained from an AI/ML model to cause the RF transceiver to operate on a wireless network in accordance with the AI/ML model.

As indicated above, FIG. 4 is provided as an example. Other examples may differ from what is described with regard to FIG. 4.

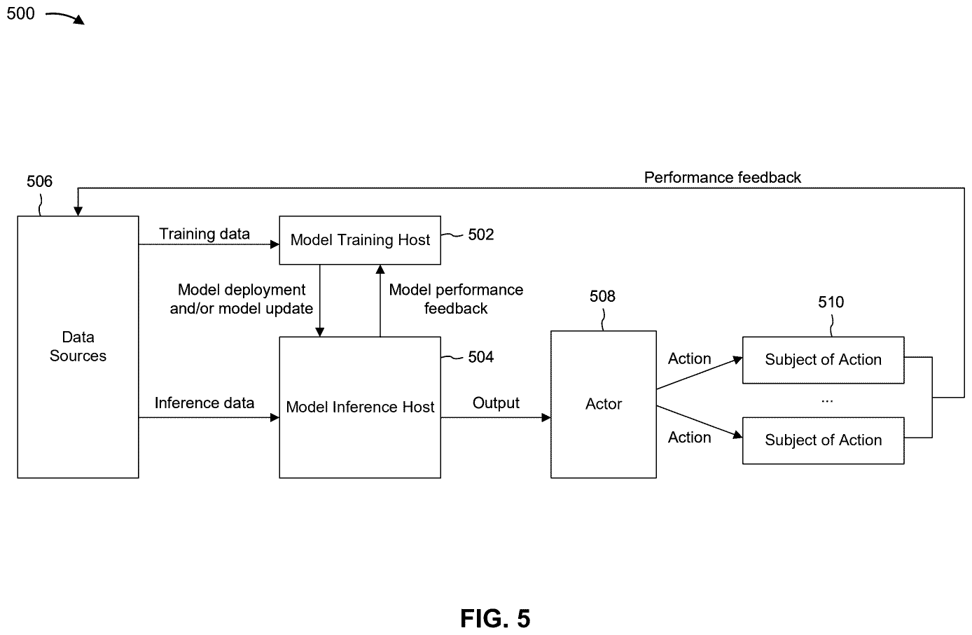

FIG. 5 is a diagram illustrating an example architecture 500 of a functional framework for RAN intelligence enabled by data collection. In some scenarios, the functional framework for RAN intelligence may be enabled by enhancement of the data collection through one or more use cases or examples. For example, principles or algorithms for RAN intelligence enabled by AI/ML and the associated functional framework (e.g., AI/ML functionalities, inputs or outputs of one or more components for AI/ML enabled optimization, or the like) may be used for one or more AI/ML air interface use cases (e.g., beam management, positioning, CSI prediction, energy saving, load balancing, mobility management, or coverage optimization, among other examples). In one example, as shown by the architecture 500, a functional framework for RAN intelligence may include multiple logical entities, such as a model training host 502, a model inference host 504, one or more data sources 506, and an actor 508.

The model inference host 504 may be configured to run an AI/ML model (such as the ANN 400) based on inference data provided by the data sources 506, and the model inference host 504 may produce an output (e.g., a prediction or inference) associated with the inference data according to an AI/ML functionality. The model inference host 504 may be, or may be included in, the device 265. As further shown in FIG. 5, the output produced by the model inference host 504 may be provided to the actor 508. The actor 508 may be an element or an entity of a core network or a RAN. For example, the actor 508 may be a network entity, a UE, a network node, a base station (e.g., a gNB), a CU, a DU, or an RU, among other examples. In addition, the actor 508 may depend on a type of tasks performed by the model inference host 504, a type of the inference data provided to the model inference host 504, or a type of the output produced by the model inference host 504. For example, if the output from the model inference host 504 is associated with interference prediction, the actor 508 may be a UE (such as the UE 220), a network node (such as the network node 210), or another network entity. In some examples, the model inference host 504 may be hosted on the actor 508. For example, a UE may be the actor 508 and may host the model inference host 504. In some aspects, a UE (e.g., the actor 508) may be a data source 506. For example, the UE may perform a measurement (e.g., a first set of beam measurements), may input the measurement to the AI/ML model at the model inference host 504 (or may provide the measurement to the model inference host 504), and may act based on an output of the AI/ML model (e.g., mapping the first set of beam measurements to a second set of beam measurements, a position, a precoder or precoding matrix, a CQI, an RI, a mobility or handover parameter, or a compressed representation of CSI feedback).

After the actor 508 receives an output from the model inference host 504, the actor 508 may determine whether to act based on the output. For example, if the actor 508 is a UE and the output from the model inference host 504 is associated with position information, the actor 508 may determine whether to report the position information, reconfigure a beam, among other examples. Additionally, or alternatively, if the actor 508 is a UE and the output from the model inference host 504 is a predicted beam measurement, the actor 508 may report predicted channel characteristics associated with one or more target resources in one or more temporal occasions. If the actor 508 determines to act based on the output, in some examples, the actor 508 may indicate the action to at least one subject of action 510.

The data sources 506 may also be configured for collecting data that is used as training data for training an AI/ML model or as inference data for feeding an AI/ML model inference operation. For example, the data sources 506 may collect data from one or more core network or RAN entities, which may include the actor 508 or the subject of action 510, and may provide the collected data to the model training host 502 for AI/ML model training. In some aspects, the model training host 502 may be co-located with the model inference host 504 or the actor 508. For example, the actor 508 or the subject of action 510 may provide performance feedback associated with the action performed by the actor 508 or the output from the model inference host 504 to the data sources 506. In some examples, the performance feedback may be used by the model training host 502 for monitoring or evaluating the AI/ML model performance. For example, the performance feedback may be used by the model training host 502 to determine whether the output (e.g., prediction or inference) provided to the actor 508 is accurate. In some examples, the model training host 502 may monitor or evaluate AI/ML model performance using a training position value, which may be provided by a node (e.g., a UE or a network node). In some examples, if the output provided by the model inference host 504 is inaccurate (or the accuracy is below an accuracy threshold), then the model training host 502 may modify or retrain the AI/ML model used by the model inference host 504 (e.g., via an AI/ML model deployment or update).

As indicated above, FIG. 5 is provided as an example. Other examples may differ from what is described with regard to FIG. 5.

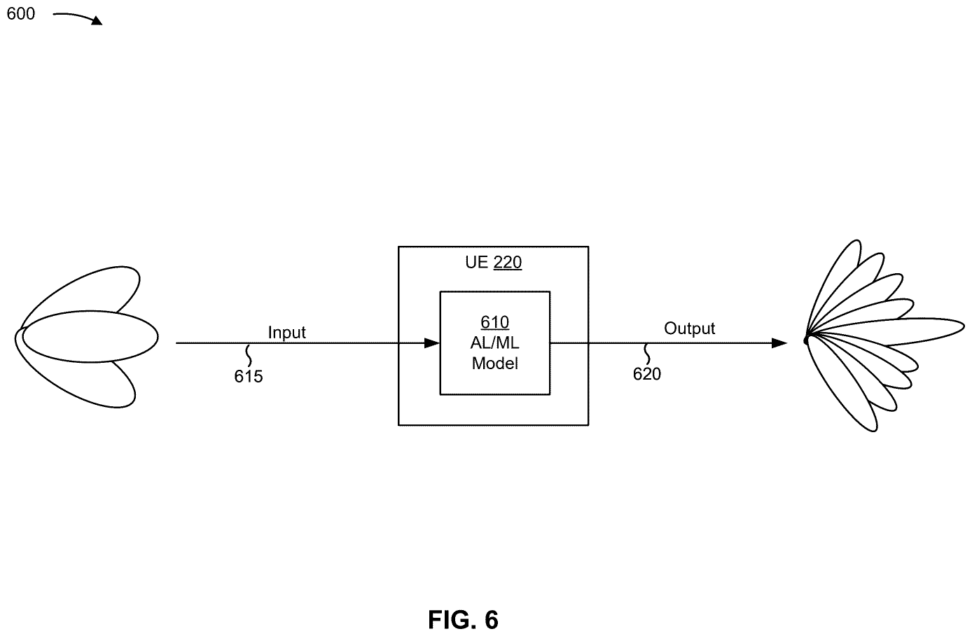

FIG. 6 is a diagram illustrating an example 600 of an AI/ML based beam management. As shown in FIG. 6, an AI/ML model 610 may be deployed at or on a UE 220. For example, a model inference host (such as the model inference host 504) may be deployed at, or on, a UE 220. The AI/ML model 610 may enable the UE 220 to determine one or more inferences or predictions based on data input to the AI/ML model 610. In some examples, the AI/ML model 610 may be, or may include, the ANN 400.

For example, as shown by reference number 615, an input to the AI/ML model 610 may include measurements associated with a first set of one or more beams. For example, a network node 210 may transmit one or more signals using respective beams from the first set of one or more beams. The UE 220 may perform measurements (e.g., L1 RSRP measurements or other measurements) of the first set of beams to obtain first measurement information. “Measurement information” may include, or indicate, one or more measurement values. For example, each beam, from the first set of beams, may be associated with one or more measurements performed by the UE 220. The UE 220 may input the first measurement information (e.g., one or more L1 RSRP measurement values or one or more SINR values) into the AI/ML model 610 along with information associated with the first set of beams or a second set of beams, such as a beam direction (e.g., spatial direction), beam width, beam shape, or other characteristics of the respective beams from the first set of beams or the second set of beams.

As shown by reference number 620, the AI/ML model 610 may output one or more predictions. The one or more predictions may include predicted information (e.g., predicted L1 RSRP measurement values, predicted interference information, or predicted SINR values) associated with the second set of beams. This may reduce a quantity of beam measurements that are performed by the UE 220, thereby conversing power of the UE 220 or network resources that would have otherwise been used to measure all beams included in the first set of beams and the second set of beams. This type of prediction may be referred to as a codebook based spatial domain selection or prediction.

As another example, an output of the AI/ML model 610 may include a point-direction, an angle of departure (AoD), or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based or non-codebook based predictions for a measurement value, an AoD, or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure), link quality or interference adaptation procedure, beam failure or beam blockage predictions, or radio link failure predictions, among other examples.

In some examples, the first set of one or more beams may be referred to as Set B beams and the second set of one or more beams may be referred to as Set A beams. In some examples, the first set of one or more beams (e.g., the Set B beams) may be a subset of the second set of one or more beams (e.g., the Set A beams). In some other examples, the first set of one or more beams and the second set of one or more beams may be different beams or may be mutually exclusive sets. For example, the first set of one or more beams (e.g., the Set B beams) may include wide beams (e.g., unrefined beams or beams having a beam width that satisfies a first threshold) and the second set of one or more beams (e.g., the Set A beams) may include narrow beams (e.g., refined beams or beams having a beam width that satisfies a second threshold). In one example, the AI/ML model 610 may perform spatial-domain beam predictions for beams included in the Set A beams based on measurement results of beams included in the Set B beams. As another example, the AI/ML model 610 may perform temporal beam prediction for beams included in the Set A beams based on historic measurement results of beams included in the Set B beams.

In some examples, the UE 220 may use the AI/ML model 610 to obtain predicted interference information. For example, the UE 220 may input interference measurement information (e.g., one or more interference measurements) to the AI/ML model 610. The AI/ML model 610 may output predicted interference information that is based on the input. The predicted interference information may be indicative of inter-cell interference for MU-MIMO operation. However, because interference information that is useful for UE pairing or grouping for MU-MIMO operation depends on both a serving beam and an interfering beam, the predicted interference information from the AI/ML model 610 may not be useful.

As indicated above, FIG. 6 is provided as an example. Other examples may differ from what is described with regard to FIG. 6.

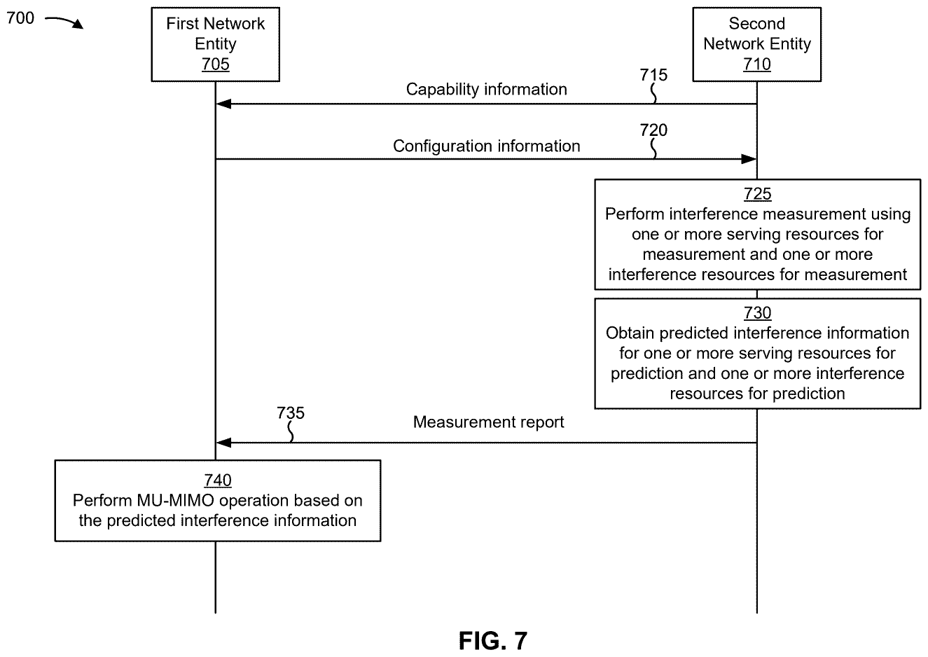

FIG. 7 is a diagram of an example 700 associated with predicted interference reporting. As shown in FIG. 7, a first network entity 705 (e.g., the network entity 106, a network node 210, a UE 220, or another network entity) may communicate with a second network entity 710 (e.g., the network entity 102, a UE 220, a network node 210, or another network entity). In some aspects, the first network entity 705 and the second network entity 710 may be part of a wireless network (e.g., the wireless communication network 200). The first network entity 705 and the second network entity 710 may have established a wireless connection prior to operations shown in FIG. 7.

In some aspects, as shown by reference number 715, the second network entity 710 may transmit capability information. The capability information may be included in a capability report. The second network entity 710 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the second network entity 710. The one or more parameters may be indicated via respective information elements (IEs) included in a capability report.

The capability information may indicate whether the second network entity 710 supports a feature or one or more parameters related to the feature. For example, the capability information may indicate a capability or parameter for MU-MIMO interference prediction. As another example, the capability information may indicate a capability or parameter for predicting interference on one or more serving resources from one or more interference resources based on measured interference on measured serving resources from one or more interference resources. One or more operations described herein may be based on capability information. For example, the second network entity 710 may perform a communication in accordance with the capability information, or may receive configuration information that is in accordance with the capability information. In some aspects, the capability information may indicate support for performing interference measurements on a set of one or more serving resources, predicting interference on a different set (or the same set) of serving beam resources, transmitting a measurement report indicating the predicted interference information to the first network entity 705, or being configured with time occasions for prediction, frequency resources for prediction, or spatial domain resources for prediction, among other examples.

As shown by reference number 720, the first network entity 705 may transmit, and the second network entity 710 may receive, configuration information. In some aspects, the second network entity 710 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the second network entity 710 or previously indicated by the network node or other network device), or explicit configuration information for the second network entity 710 to use to configure the second network entity 710, among other examples.

In some examples, the configuration information may not be expressly signaled to the second network entity 710. For example, in some aspects, the configuration information may at least partially be defined by a wireless communication standard, such as the 3GPP. In such examples, the first network entity 705 may not explicitly indicate such configuration information to the second network entity 710. For example, the second network entity 710 may optionally obtain at least a portion of the configuration information from a configuration stored by the second network entity 710 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the second network entity 710 is to predict interference information for one or more serving resources for prediction (e.g., prediction serving resources) caused by one or more interference resources for prediction (e.g., prediction interference resources). For example, the configuration information may indicate that the second network entity 710 is to transmit a measurement report that indicates predicted interference information for the one or more prediction serving resources and the one or more prediction interference resources (e.g., the configuration information may indicate that the second network entity 710 is to report the predicted interference information). The configuration information may indicate one or more serving resources for measurement (e.g., measurement serving resources) and one or more interference resources for measurement (e.g., measurement interference resources). The one or more measurement serving resources and the one or more measurement interference resources may be configured for measurement by the second network entity 710 (e.g., to enable the second network entity 710 to obtain interference measurement information). The second network entity 710 may be configured to use the interference measurement information to predict or obtain the predicted interference information, as described in more detail elsewhere herein.

For example, the configuration information may indicates a first set of one or more serving resources for measurement (e.g., one or more measurement serving resources) and a second set of one or more serving resources for prediction (e.g., one or more prediction serving resources). The first set of one or more serving resources may be associated with a third set of one or more interference resources for measurement (e.g., one or more measurement interference resources). For example, the configuration information may indicate that the second network entity 710 is to measure interference on the one or more measurement serving resources that is caused by the one or more measurement interference resources. The second set of one or more serving resources may be associated with a fourth set of one or more interference resources for prediction (e.g., one or more prediction interference resources). For example, the configuration information may indicate that the second network entity 710 is to predict interference on the one or more prediction serving resources that would be caused by the one or more prediction interference resources. The configuration information may indicate the first set of one or more serving resources for measurement, the second set of one or more serving resources for prediction, the third set of one or more interference resources for measurement, and the fourth set of one or more interference resources for prediction.

In some aspects, the first set of one or more serving resources for measurement may be referred to as a Set B. The second set of one or more serving resources for prediction may be referred to as a Set A. The third set of one or more interference resources for measurement may be referred to as a Set B_{Interference}. The fourth set of one or more interference resources for measurement may be referred to as a Set A_{Interference}.

In some aspects, the first set of one or more serving resources and the second set of one or more serving resources may be the same (e.g., may be the same set of one or more resources). For example, the configuration information may configure same one or more serving resources for both measurement and prediction. For example, the second network entity 710 may be configured to measure and predict interference for the same serving resource(s) (e.g., for the same serving beam(s)). This may simplify the resource allocation process and reduce the complexity of scheduling and configuration for the first network entity 705.

In some aspects (e.g., where the first set of one or more serving resources and the second set of one or more serving resources are the same), the third set of one or more interference resources may include one or more first interference resources, and the fourth set of one or more interference resources may include one or more second interference resources. For example, for one or more serving resources, the second network entity 710 may be configured to measure interference for the one or more serving resources caused by the one or more first interference resources. The second network entity 710 may be configured to predict interference for the one or more serving resources caused by the one or more second interference resources. For example, the configuration information may indicate that beams {10, 12, 14} are the first one or more interference resources and that beams {2, 4, 5} are the second one or more interference resources.

In some aspects, the one or more first interference resources may be different than the one or more second interference resources. For example, at least one interference resource may not be common between the or more first interference resources and the one or more second interference resources. In some aspects, the first one or more interference resources used for measurement may be exclusive or distinct from the second one or more interference resources used for prediction.

In some aspects, the third set of one or more interference resources (e.g., the one or more measurement interference resources) may be a subset of the fourth set of one or more interference resources (e.g., the one or more prediction interference resources). For example, the one or more measurement interference resources may be a smaller group included within the larger set of he one or more prediction interference resources. In other aspects, the third set of one or more interference resources (e.g., the one or more measurement interference resources) and the fourth set of one or more interference resources (e.g., the one or more prediction interference resources) may be mutually exclusive sets.

In some aspects, the third set of one or more interference resources (e.g., the one or more measurement interference resources) and the fourth set of one or more interference resources (e.g., the one or more prediction interference resources) may be the same (e.g., may be the same set of one or more interference resources). For example, the second network entity 710 may be configured to use the same one or more resources (e.g., beams) as interfering beams for both measurement and prediction of interference. In such aspects, the first set of one or more serving resources (e.g., the one or more measurement serving resources) may include one or more first serving resources, and the second set of one or more serving resources (e.g., the one or more prediction serving resources) may include one or more second serving resources. In some aspects, the one or more first serving resources may be different than the one or more second serving resources. For example, the second network entity 710 may be configured to measure interference on the one or more first serving resources that is caused by one or more interference resources. The second network entity 710 may be configured to predict interference on the one or more second serving resources that is caused by the one or more interference resources (e.g., the same one or more interference resources).

In some aspects, the first set of one or more serving resources (e.g., the one or more measurement serving resources) may be a subset of the second set of one or more serving resources (e.g., the one or more prediction serving resources). For example, where the one or more measurement interference resources and the one or more prediction interference resources are the same, the one or more measurement serving resources may be a subset of the one or more prediction serving resources. For example, the second network entity 710 may be configured with serving resources for measurements that form a smaller part of the broader set of servicing resources for predictions.

In some aspects, the first set of one or more serving resources (e.g., the one or more measurement serving resources) may be a subset of the second set of one or more serving resources (e.g., the one or more prediction resources). Additionally, the third set of one or more interference resources (e.g., the one or more measurement interference resources) may be a subset of the fourth set of one or more interference resources (e.g., the one or more prediction interference resources). For example, both serving and interference resources configured for measurement may be subsets of serving and interference resources configured for prediction. This hierarchical structuring may improve the efficiency of the prediction process.

In some aspects, each serving resource included in the first set of one or more serving resources (e.g., the one or more measurement serving resources) may be associated with one or more respective interference resources included in the third set of one or more interference resources (e.g., the one or more measurement interference resources). For example, each serving resources included in the first set of one or more serving resources may be associated with a different one or more interference resources. In other words, the serving resource(s) included in the one or more measurement serving resources may not each be associated with the same interference resources from the one or more measurement interference resources. In some aspects, each serving resource included in the second set of one or more serving resources (e.g., the one or more prediction serving resources) may be associated with one or more respective interference resources included in the fourth set of one or more interference resources (e.g., the one or more prediction interference resources). In some examples, each serving resources included in the second set of one or more serving resources may be associated with a different one or more interference resources. In other words, the serving resource(s) included in the one or more prediction serving resources may not each be associated with the same interference resources from the one or more prediction interference resources. For example, each measured serving resource may be linked with one or more interference resources. Similarly, each serving resource configured for prediction may be linked with one or more interference resources.

In some aspects, the first set of one or more serving resources may be different than the second set of one or more serving resources, and the third set of one or more interference resources may be different than the fourth set of one or more interference resources. For example, the first set of one or more serving resources may be disjoint from or mutually exclusive from the second set of one or more serving resources. Similarly, the third set of one or more interference resources may be disjoint from or mutually exclusive from the fourth set of one or more interference resources. For example, the resources used for measurement may be entirely different from those used for prediction.

In some aspects, the first set of one or more serving resources (e.g., the one or more measurement serving resources) and the third set of one or more interference resources (e.g., the one or more measurement interference resources) may be associated with a first type of resource. The second set of one or more serving resources (e.g., the one or more prediction serving resources) and the fourth set of one or more interference resources (e.g., the one or more prediction interference resources) may be associated with a second type of resource. In some aspects, the first type of resource may be a wide beam resource and the second type of resource may be a narrow beam resource. For example, the first type of resource might be SSB resources and the second type of resource may be CSI-RS resources.

In some aspects, the configuration information may be CSI configuration information. For example, the configuration information may include a CSI configuration. The CSI report configuration may be configured per BWP. A resource set may have Ks resources with the same quantity of CSI-RS ports. If Ks is equal to 1, each resource may contain 32 CSI-RS ports (for example, if the first network entity 705 associated with the CSI report configuration includes 32 antenna ports). If Ks is equal to 2, each resource may contain at most 16 CSI-RS ports. For Ks equal to 2 through 8, each resource may contain up to 8 CSI-RS ports. A P-port resource has ports labeled from 3000 to 3000(P-1).

The CSI report configuration may include a CSI resource setting for a channel measurement resource (CMR), a CSI resource setting for CMR and CSI interference measurement (CSI-IM) or non-zero power (NZP) interference measurement resource (IMR), and a CSI resource setting for CMR and CSI-IM and NZP-IMR. A CMR may be associated with estimating channel conditions. For example, the second network entity 710 may be configured to measure a CMR to estimate the channel conditions (for example, the second network entity 710 may measure a CMR to perform a channel measurement, such as an RSRP measurement). An IMR or a CSI-IM resource may be associated with estimating interference associated with a channel. For example, the second network entity 710 may measure an IMR or a CSI-IM resource to estimate the interference (for example, the second network entity 710 may measure an IMR to perform an interference measurement). Each resource setting may have one active resource set, and each resource set may have one or more resources (N resources). The CSI report configuration may also be referred to as a “CSI report setting.”

The configuration information may include, or indicate, CSI configuration information. In some aspects, the CSI configuration information may include or indicate a CSI configuration (e.g., a CSI-ReportConfig). For example, the configuration information may include a CSI report configuration or a CSI report setting, among other examples. In some aspects, the configuration information may indicate one or more CSI-RS resource configurations (e.g., a CSI-ResourceConfig). For example, the CSI configuration information may indicate (e.g., configure) multiple CSI-RS resources. In some aspects, the resources described herein (e.g., measurement serving resources, prediction serving resources, measurement interference resources, or prediction interference resources) may be configured via the CSI configuration information. For example, the resources described herein (e.g., measurement serving resources, prediction serving resources, measurement interference resources, or prediction interference resources) may be CSI-RS resources.

The one or more CSI-RS resource configurations may be NZP CSI-RS resource configurations. For example, the resources described herein (e.g., measurement serving resources, prediction serving resources, measurement interference resources, or prediction interference resources) may be configured via an NZP CSI-RS resource configuration (e.g., an nzp-CSI-RS-ResourceSetList, among other examples). The CSI configuration information may indicate a CSI report configuration or a CSI reporting setting. The CSI report configuration or the CSI reporting setting may indicate the multiple CSI-RS resource configurations. In some aspects, the one or more CSI-RS resource configurations may be included in one or more CSI-RS resource sets.

In some aspects, the configuration information may indicate that a prediction resource, from the second set of one or more serving resources or the fourth set of one or more interference resources, is an NZP resource. In some aspects, an NZP CSI-RS resource configuration may indicate one or more transmission parameters for an NZP resource. For example, the NZP CSI-RS resource configuration may indicate one or more transmission parameters for an NZP resource (e.g., a serving resource or an interference resource) that is configured for prediction (e.g., rather than measurement). The one or more transmission parameters may include a periodicity and offset (e.g., a periodicityAndOffset) for periodic or semi-persistent resources, a power control offset (e.g., a powerControlOffset) indicating a power offset of a PDSCH resource element to an NZP CSI-RS resource element, a synchronization signal power offset (e.g., a powerControlOffsetSS) indicating a power offset of the NZP CSI-RS resource element to a synchronization signal resource element, a QCL parameter (e.g., a qcl-InfoPeriodicCSI-RS) indicating a TCI state identifier to which the CSI-RS resource is quasi co-located, or a time and frequency allocation for the NZP CSI-RS (e.g., a CSI-RS-ResourceMapping), among other examples. In some aspects, the second network entity 710 may be configured to use the one or more transmission parameters to predict interference associated with the prediction resource.

In some aspects, the CSI configuration information includes one or more first flags that indicate that the first set of one or more serving resources and the third set of one or more interference resources are for measurement. In some aspects, the CSI configuration information includes one or more second flags that indicate that the second set of one or more serving resources and the fourth set of one or more interference resources are for prediction. For example, a CSI resource configuration (e.g., a CSI-ResourceConfig) may include a flag that indicates whether CSI-RS resources included in the CSI resource configuration are configured for measurement or prediction. For example, a flag may be used to label resources for measurement versus prediction purposes.

In some aspects, the CSI configuration information may include CSI report configuration information. In such examples, the CSI report configuration information may indicate that the second network entity 710 is to transmit a predicted interference report. For example, the report configuration might specify the format and content for predicted interference reports. This can facilitate standardized reporting and more effective network management. In some aspects, the CSI report configuration information may indicate that the measurement report is a predicted inter-cell interference measurement report. For example, the report might include details on predicted interference from adjacent cells. For example, a CSI report quantity indicated by a CSI report configuration may indicate that the CSI report is for predicted interference. The CSI report quantity may indicate whether the reported interference is a predicted MU-MIMO interference or a predicted inter-cell interference. An IE in the CSI report configuration may indicate whether the reported interference is for MU-MIMO interference, inter-cell interference, or another type of interference.

In some aspects, the CSI report configuration information may indicate that the measurement report is a predicted MU-MIMO interference report. In some aspects, the CSI report configuration information indicates that the measurement report is the predicted MU-MIMO interference report based on at least one resource from the second set or the fourth set (e.g., at least one a prediction resource) being configured as an NZP resource (e.g., an NZP CSI-RS resource).

The second network entity 710 may configure itself based at least in part on the configuration information. In some aspects, the second network entity 710 may be configured to perform one or more operations described herein based at least in part on the configuration information.

As shown by reference number 725, the second network entity 710 may perform, based on the first set of one or more serving resources, one or more measurements to obtain interference measurement information associated with the third set of one or more interference resources. For example, for a given measurement serving resource, the second network entity 710 may set or adjust a receive (Rx) filter of the second network entity 710 based on the given measurement serving resource. For example, the given measurement serving resource may be associated with spatial direction information (e.g., a beam). The second network entity 710 may configure receiver (or transceiver) of the second network entity 710 to be more sensitive to signals coming from the direction of the serving resource. For example, the second network entity 710 may tune one or more parameters of the receiver to align with the characteristics of the serving beam, such as a frequency, phase, or spatial direction used by the receiver. After setting the Rx filter based on the given measurement serving resource, the second network entity 710 may measure one or more signals associated with one or more measurement interference resources that are associated with, or mapped to, the given measurement serving resource (e.g., as indicated by the configuration information).

For example, the first network entity 705 may transmit the one or more signals via the one or more measurement interference resources. The second network entity 710 may measure the one or more signals (e.g., with the Rx filter set based on the given measurement serving resource). The second network entity 710 may obtain interference measurement information for the given measurement serving resource from the measurement(s). For example, the interference measurement information for the given measurement may indicate one or more interference values (e.g., power values, SINR values, signal-to-interference ratio (SNR) values, or an interference covariance matrix). The second network entity 710 may obtain interference measurement information for all combinations of measurement serving resources and measurement interference resources as configured by the configuration information in a similar manner. In this way, the second network entity 710 may obtain interference measurement information for the combinations of measurement serving resources and measurement interference resources as configured by the configuration information.

As shown by reference number 730, the second network entity 710 may obtain predicted interference information. For example, the second network entity 710 may obtain predicted interference information for one or more serving resources for prediction and one or more interference resources for prediction. The second network entity 710 may obtain, based on the second set of one or more serving resources (e.g., the one or more prediction serving resources) and the interference measurement information (e.g., obtained by the second network entity 710 as described in connection with reference number 725), predicted interference information associated with the fourth set of one or more interference resources (e.g., the one or more prediction interference resources). In some aspects, the predicted interference information may indicate a predicted interference power, a predicted interference covariance matrix, or a predicted SINR, among other examples.

For example, the predicted interference information may indicate predicted MU-MIMO interference in a scenario the one or more prediction serving resources are serving resource(s) for the second network entity 710 and the one or more prediction interference resources are serving resource(s) for one or more other network entities that are paired or grouped with the second network entity 710 for MU-MIMO operation. By the first network entity 705 configuring the one or more prediction serving resources and the one or more prediction interference resources, the second network entity 710 can obtain the predicted interference information that is indicative of the predicted MU-MIMO interference.

In some aspects, the interference measurement information may indicate interference measurements for a serving resource (e.g., a first beam) and one or more interfering resources (e.g., a second beam, a third beam, and a fourth beam). The second network entity 710 may use the interference measurement information to predict the predicted interference information for the serving resource (e.g., the first beam) and one or more interfering resources (e.g., a fifth beam, a sixth beam, or a seventh beam). As another example, the interference measurement information may indicate interference measurements for multiple serving resource (e.g., a first beam, a second beam, and a third beam) and one or more interfering resources (e.g., a fourth beam). The second network entity 710 may use the interference measurement information to predict the predicted interference information for the one or more interfering resources (e.g., the fourth beam) and one or more other serving resources (e.g., a fifth beam, a sixth beam, or a seventh beam).

As another example, the second network entity 710 may be configured with resources (e.g., CSI-RS resources) having beam indices 1 through 16. The configuration information may indicate that the one or more measurement serving resources include resources associated with beam indices {3, 6}. The configuration information may indicate that the one or more measurement interference resources include resources associated with beam indices {10, 11, 12, 13, 14, 15}. In some examples, the configuration information may indicate that the one or more measurement interference resources for the measurement serving resource {3} include resources associated with beam indices {10, 12, 14} and the one or more measurement interference resources for the measurement serving resource {6} include resources associated with beam indices {11, 13, 15}. The second network entity 710 may measure the interference for the measurement serving resource {3} and the measurement interference resources{10, 12, 14}. Additionally, the second network entity 710 may measure the interference for the measurement serving resource {6} and the measurement interference resources{11, 13, 15}. The configuration information may indicate that the prediction serving resources include resources associated with beam indices {2, 4, 5} and the prediction interference resources include resources associated with beam indices {10, 11, 12, 14, 14, 15}. Based on the interference measurement information, the second network entity 710 may predict MU-MIMO interference for the prediction serving resources and the prediction interference resources.

In some aspects, a prediction resource may be configured as an NZP resource (e.g., an NZP CSI-RS resource, as described elsewhere herein). In such examples, the second network entity 710 may obtain one or more predicted interference values for the prediction resource using one or more transmission parameters indicated by the configuration of the NZP resource. For example, the second network entity 710 may provide the one or more transmission parameters as an input to an AI/ML model, such as the ANN 400, or the AI/ML model 610, among other examples. For example, the second network entity 710 may predict the MU-MIMO interference using the parameters indicated in the CSI-resource-config of the NZP prediction resource. The one or more transmission parameters may include a periodicity and offset (e.g., a periodicityAndOffset) for periodic or semi-persistent resources, a power control offset (e.g., a powerControlOffset)) indicating a power offset of a PDSCH resource element to an NZP CSI-RS resource element, a synchronization signal power offset (e.g., a powerControlOffsetSS) indicating a power offset of the NZP CSI-RS resource element to a synchronization signal resource element, a QCL parameter (e.g., a qcl-InfoPeriodicCSI-RS) indicating a TCI state identifier to which the CSI-RS resource is quasi co-located, or a time and frequency allocation for the NZP CSI-RS (e.g., a CSI-RS-ResourceMapping), among other examples.

In some aspects, the predicted interference information (e.g., predicted MU-MIMO interference) may be predicted in time (e.g., in milliseconds), frequency (e.g., sub-bands, BWPs, or component carriers CCs), or space (e.g., spatial directions or beams), among other examples. In some aspects, the second network entity 710 may perform the one or more measurements (e.g., as described in connection with reference number 725) during one or more first time occasions. The second network entity 710 may obtain one or more predicted interference values for one or more second time occasions, where the one or more second time occasions are after the one or more first time occasions. For example, the second network entity 710 may be configured to predict MU-MIMO interference for future time occasions (e.g., future symbols, slots, subframe, frames, or other future time occasions). For example, the measurements may be conducted in earlier time occasions, and predictions made for subsequent time occasions. In some aspects, the configuration information indicates the one or more second time occasions (e.g., the future time occasions). For example, the configuration may indicate one or more time occasions for prediction (e.g., the one or more second time occasions).

In some aspects, the second network entity 710 may perform the one or more measurements (e.g., as described in connection with reference number 725) via one or more first frequency resources. The second network entity 710 may obtain one or more predicted interference values for one or more second frequency resources, where the one or more second frequency resources are different than the one or more first frequency resources. For example, measurements might be conducted on certain frequency sub-bands, BWPs, or component carriers, while predictions are made for different sub-bands, BWPs, or component carriers.

In some aspects, the second network entity 710 may obtain the predicted interference information via an AI/ML model in a similar manner as described in connection with FIGS. 4-6. For example, the AI/ML model may be, or may include, the ANN 400, the AI/ML model 610, or another AI/ML model. In some aspects, the second network entity 710 may be, may include, or may communicate with a model inference host (e.g., the model inference host 504).

In some aspects, input to the AI/ML model for interference prediction may include sparse interference measurements on subsets of time slots, frequency sub-bands, or beams, among other examples. For example, the interference measurement information may be associated with specific time slots, sub-bands, or beams to provide a data set for the AI/ML model. This allows for a more efficient and focused data collection process. In some aspects, output of the AI/ML model for interference prediction may include predicted interference on a subset of beams, time slots, or sub-bands, among other examples. For example, the AI/ML model may predict interference on future CSI-RS beams, time slots, and frequency sub-bands based on the sparse input data. This can help in making more accurate and timely interference predictions.

As shown by reference number 735, the second network entity 710 may transmit, and the first network entity 705 may receive, a measurement report. The measurement report may indicate the predicted interference information. In some aspects, the measurement report may indicate the interference measurement information (e.g., in addition to the predicted interference information). The second network entity 710 may transmit the measurement report in accordance with the configuration information, such as a CSI report configuration.

In some aspects, the measurement report may indicate interference information for all measured or predicted resources (e.g., all measured or predicted beams). In some other aspects, the measurement report may indicate interference information for a best K resources (e.g., best in terms of the measured or predicted interference). For example, the best K resources may be the lowest K resources in terms of measured or predicted interference power. As another examples, the best K resources may be a top K resources in terms of measured or predicted SINR.

In some aspects, as shown by reference number 740, the first network entity 705 may perform a MU-MIMO operation based on the predicted interference information the interference measurement information. For example, the first network entity 705 may pair or group the second network entity 710 with one or more other network entities in MU-MIMO operation based on the interference information. For example, based on the best measured or predicted interference indicated in the measurement report, the first network entity 705 may identify another network entity that can be served by an interfering resource that resulted in the best measured or predicted interference for the second network entity 710. This leads to better spectral efficiency and reduced inter-user interference, enhancing the overall network performance. Additionally, by the second network entity 710 transmitting a measurement report that indicates the predicted interference information, the first network entity 705 may have access to more interference information when making pairing or grouping determinations for MU-MIMO operations (e.g., without increasing a measurement overhead for the second network entity 710). By the first network entity 705 having access to more interference information, the first network entity 705 may make improved pairing or grouping determinations for MU-MIMO operations.

As indicated above, FIG. 7 is provided as an example. Other examples may differ from what is described with respect to FIG. 7.

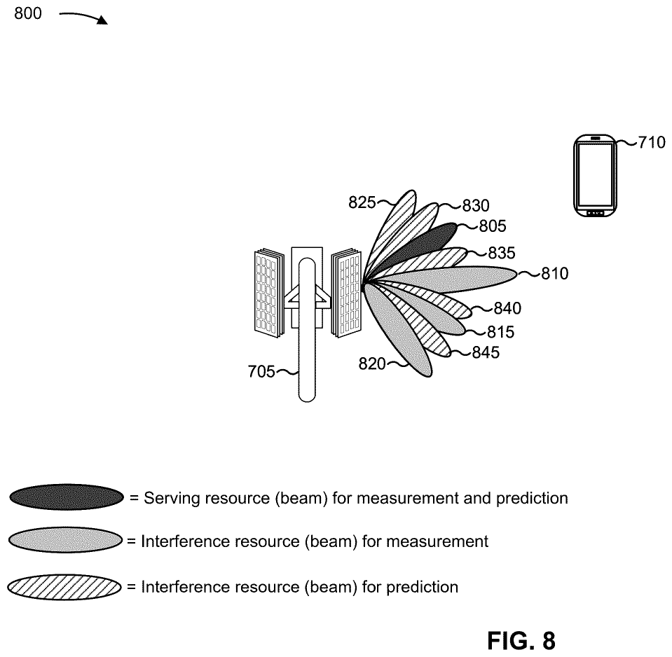

FIG. 8 is a diagram of an example 800 associated with predicted interference reporting. As shown in FIG. 8, the first network entity 705 may be capable of transmitting signals using different resources, such as a resource 805, a resource 810, a resource 815, a resource 820, a resource 825, a resource 830, a resource 835, a resource 840, and a resource 845. The resources are depicted in FIG. 8 as beams. The second network entity 710 may be configured to measure or predict interference for one or more serving resources and one or more interference resources, as described elsewhere herein.

In the example 800, the resource 805 may be configured as a serving resource for the second network entity 710. The resource 805 may be configured as the measurement serving resource and the predicted serving resource. For example, the first set of one or more serving resources for measurement and the second set of one or more serving resources for prediction may be the same and may be a single resource (e.g., the resource 805). The second network entity 710 may be configured with one or more interference resources for measurement, such as the resource 810, the resource 815, and the resource 820. The first network entity 705 may transmit one or more signals via the one or more interference resources for measurement. The second network entity 710 may measure interference caused by the one or more signals (e.g., where an Rx filter of the second network entity 710 is set based on the resource 805) to obtain interference measurement information. The second network entity 710 may use the interference measurement information and information associated with the resource 805 (e.g., a spatial direction or other parameters) to predict interference values for one or more interference resources for prediction, such as the resource 825, the resource 830, the resource 835, the resource 840, and the resource 845. For example, the second network entity 710 may obtain predicted interference information that indicates predicted interference values or levels on the resource 805 that would be caused by transmissions via the one or more interference resources for prediction (e.g., using an AI/ML model, as described in more detail elsewhere herein). As a result, the first network entity 705 may obtain interference information for multiple interference resources (e.g., which may be candidate serving resources for other network entities in a MU-MIMO operation) for a given serving resource of the second network entity 710.

As indicated above, FIG. 8 is provided as an example. Other examples may differ from what is described with respect to FIG. 8.

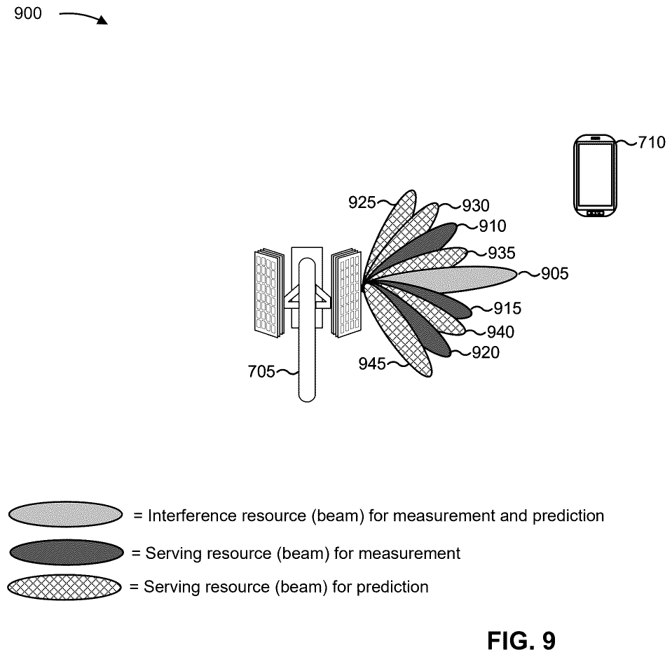

FIG. 9 is a diagram of an example 900 associated with predicted interference reporting. As shown in FIG. 9, the first network entity 705 may be capable of transmitting signals using different resources, such as a resource 905, a resource 910, a resource 915, a resource 920, a resource 925, a resource 930, a resource 935, a resource 940, and a resource 945. The resources are depicted in FIG. 9 as beams. The second network entity 710 may be configured to measure or predict interference for one or more serving resources and one or more interference resources, as described elsewhere herein.

In the example 900, the resource 905 may be configured as an interference resource for both measurement and prediction. For example, the third set of one or more interference resources for measurement and the fourth set of one or more interference resources for prediction may be the same and may include only the resource 905. In such examples, the second network entity 710 may be configured with one or more serving resources for measurement, such as the resource 910, the resource 915, and the resource 920. The second network entity 710 may measure interference on the one or more serving resources for measurement caused by a transmission on the resource 905. For example, the first network entity 705 may transmit one or more signals via the resource 905. The second network entity 710 may adjust an Rx filter to a given serving resource for measurement and measure a signal transmitted via the resource 905. The second network entity 710 may continue this process (e.g., adjusting the Rx filter and measuring interference) for all of the one or more serving resources for measurement to obtain the interference measurement information.

The second network entity 710 may be configured with one or more serving resources for prediction, such as the resource 925, the resource 930, the resource 935, the resource 940, and the resource 945. The second network entity 710 may use the interference measurement information and information associated with the one or more serving resources for prediction (e.g., spatial directions or other parameters) to predict interference values for one or more serving resources for prediction. For example, the second network entity 710 may obtain predicted interference information that indicates predicted interference values or levels on the one or more serving resources for prediction that would be caused by transmissions via the resource 905 (e.g., using an AI/ML model, as described in more detail elsewhere herein). As a result, the first network entity 705 may obtain interference information that would be caused by transmissions via the resource 905 (e.g., which may be selected as a serving resource for another network entity) on multiple serving resources for the second network entity 710.

As indicated above, FIG. 9 is provided as an example. Other examples may differ from what is described with respect to FIG. 9.

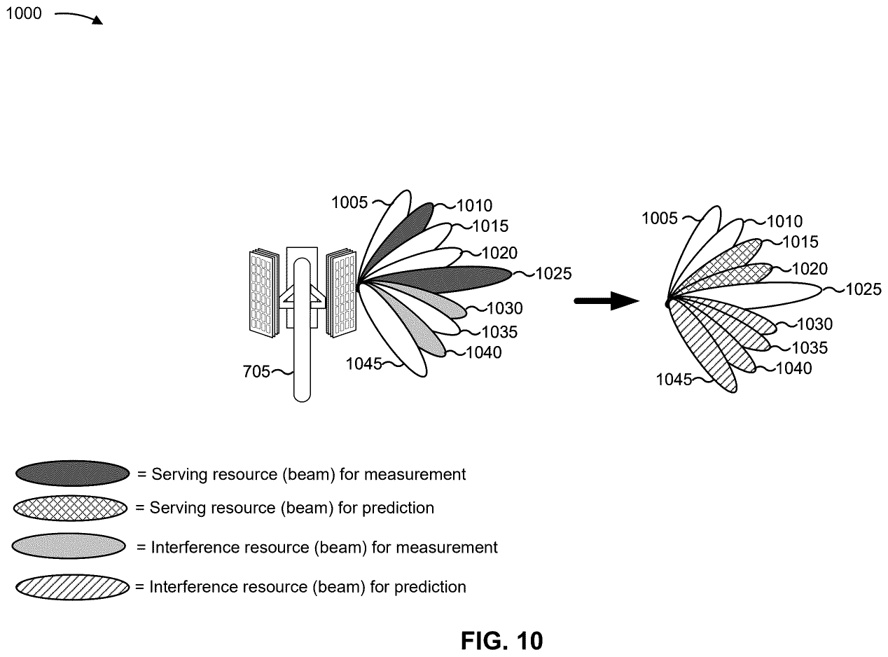

FIG. 10 is a diagram of an example 1000 associated with predicted interference reporting. As shown in FIG. 10, the first network entity 705 may be capable of transmitting signals using different resources, such as a resource 1005, a resource 1010, a resource 1015, a resource 1020, a resource 1025, a resource 1030, a resource 1035, a resource 1040, and a resource 1045. The resources are depicted in FIG. 10 as beams.

As shown in FIG. 10, the resource 1010 and the resource 1025 may be configured as serving resources for measurement (e.g., for interference measurement(s) by the second network entity 710), such as Set B resources. The resource 1030 and the resource 1040 may be configured as interference resources for measurement, such as Set B_{Interference} resources. As an example, the second network entity 710 may be configured to measure interference on the resource 1010 caused by a transmission on the resource 1030. Similarly, the second network entity 710 may be configured to measure interference on the resource 1025 caused by a transmission on the resource 1040.

The resource 1015 and the resource 1020 may be configured as serving resources for prediction, such as Set A resources. The resource 1030, the resource 1035, the resource 1040, and the resource 1045 may be configured as interference resources for prediction, such as Set A_{Interference} resources. The second network entity 710 may be configured to obtain predicted interference information for the Set A resources that is predicted to be caused by the Set A_{Interference} resources.

As indicated above, FIG. 10 is provided as an example. Other examples may differ from what is described with respect to FIG. 10.

FIG. 11 is a diagram illustrating an example process 1100 performed, for example, at a network entity or an apparatus of a network entity. Example process 1100 is an example where the apparatus or the network entity (e.g., the second network entity 710) performs operations associated with predicted interference reporting.

As shown in FIG. 11, in some aspects, process 1100 may include receiving configuration information that indicates a first set of one or more serving resources for measurement and a second set of one or more serving resources for prediction, where the first set of one or more serving resources is associated with a third set of one or more interference resources for measurement, and where the second set of one or more serving resources is associated with a fourth set of one or more interference resources for prediction (block 1110). For example, the network entity (e.g., using reception component 1302 or communication manager 1306, depicted in FIG. 13) may receive configuration information that indicates a first set of one or more serving resources for measurement and a second set of one or more serving resources for prediction, where the first set of one or more serving resources is associated with a third set of one or more interference resources for measurement, and where the second set of one or more serving resources is associated with a fourth set of one or more interference resources for prediction, as described above.

As further shown in FIG. 11, in some aspects, process 1100 may include performing, based on the first set of one or more serving resources, one or more measurements to obtain interference measurement information associated with the third set of one or more interference resources (block 1120). For example, the network entity (e.g., using communication manager 1306, depicted in FIG. 13) may perform, based on the first set of one or more serving resources, one or more measurements to obtain interference measurement information associated with the third set of one or more interference resources, as described above.

As further shown in FIG. 11, in some aspects, process 1100 may include obtaining, based on the second set of one or more serving resources and the interference measurement information, predicted interference information associated with the fourth set of one or more interference resources (block 1130). For example, the network entity (e.g., using communication manager 1306, depicted in FIG. 13) may obtain, based on the second set of one or more serving resources and the interference measurement information, predicted interference information associated with the fourth set of one or more interference resources, as described above.

As further shown in FIG. 11, in some aspects, process 1100 may include transmitting a measurement report that indicates the predicted interference information (block 1140). For example, the network entity (e.g., using transmission component 1304 or communication manager 1306, depicted in FIG. 13) may transmit a measurement report that indicates the predicted interference information, as described above.

Process 1100 may include additional aspects, such as any single aspect or any combination of aspects described below or in connection with one or more other processes described elsewhere herein.

In a first aspect, the first set of one or more serving resources and the second set of one or more serving resources are a same set of one or more serving resources.

In a second aspect, alone or in combination with the first aspect, the third set of one or more interference resources includes one or more first interference resources, and where the fourth set of one or more interference resources includes one or more second interference resources.

In a third aspect, alone or in combination with one or more of the first and second aspects, the one or more first interference resources are different than the one or more second interference resources.

In a fourth aspect, alone or in combination with one or more of the first through third aspects, the third set of one or more interference resources is a subset of the fourth set of one or more interference resources.

In a fifth aspect, alone or in combination with one or more of the first through fourth aspects, the third set of one or more interference resources and the fourth set of one or more interference resources are a same set of one or more interference resources.

In a sixth aspect, alone or in combination with one or more of the first through fifth aspects, the first set of one or more serving resources includes one or more first serving resources, and where the second set of one or more serving resources includes one or more second serving resources.

In a seventh aspect, alone or in combination with one or more of the first through sixth aspects, the one or more first serving resources are different than the one or more second serving resources.

In an eighth aspect, alone or in combination with one or more of the first through seventh aspects, the first set of one or more serving resources is a subset of the second set of one or more serving resources.

In a ninth aspect, alone or in combination with one or more of the first through eighth aspects, the first set of one or more serving resources is a subset of the second set of one or more serving resources, and where the third set of one or more interference resources is a subset of the fourth set of one or more interference resources.

In a tenth aspect, alone or in combination with one or more of the first through ninth aspects, each serving resource included in the first set of one or more serving resources is associated with one or more respective interference resources included in the third set of one or more interference resources, and where each serving resource included in the second set of one or more serving resources is associated with one or more respective interference resources included in the fourth set of one or more interference resources.

In an eleventh aspect, alone or in combination with one or more of the first through tenth aspects, the first set of one or more serving resources is different than the second set of one or more serving resources, and where the third set of one or more interference resources is different than the fourth set of one or more interference resources.

In a twelfth aspect, alone or in combination with one or more of the first through eleventh aspects, the first set of one or more serving resources and the third set of one or more interference resources are associated with a first type of resource, and where the second set of one or more serving resources and the fourth set of one or more interference resources are associated with a second type of resource.

In a thirteenth aspect, alone or in combination with one or more of the first through twelfth aspects, the first type of resource is a synchronization signal block resource, and where the second type of resource is a channel state information reference signal resource.

In a fourteenth aspect, alone or in combination with one or more of the first through thirteenth aspects, the configuration information includes CSI configuration information.

In a fifteenth aspect, alone or in combination with one or more of the first through fourteenth aspects, the CSI configuration information includes one or more first flags that indicate that the first set of one or more serving resources and the third set of one or more interference resources are for measurement, and where the CSI configuration information includes one or more second flags that indicate that the second set of one or more serving resources and the fourth set of one or more interference resources are for prediction.

In a sixteenth aspect, alone or in combination with one or more of the first through fifteenth aspects, the CSI configuration information indicates that a resource, from the second set of one or more serving resources or the fourth set of one or more interference resources, is a non-zero-power resource, where the CSI configuration information indicates one or more transmission parameters for the non-zero-power resource, and where obtaining the predicted interference information includes obtaining one or more predicted interference values associated with the non-zero power resource, where the one or more predicted interference values are based on the one or more transmission parameters.

In a seventeenth aspect, alone or in combination with one or more of the first through sixteenth aspects, the configuration information includes CSI report configuration information, and where the CSI report configuration information indicates that the measurement report is a predicted interference report.

In an eighteenth aspect, alone or in combination with one or more of the first through seventeenth aspects, the CSI report configuration information indicates that the measurement report is a predicted MU-MIMO interference report.

In a nineteenth aspect, alone or in combination with one or more of the first through eighteenth aspects, the CSI report configuration information indicates that the measurement report is the predicted MU-MIMO interference report based on at least one resource from the second set or the fourth set being configured as a non-zero-power resource.

In a twentieth aspect, alone or in combination with one or more of the first through nineteenth aspects, the CSI report configuration information indicates that the measurement report is a predicted inter-cell interference measurement report.

In a twenty-first aspect, alone or in combination with one or more of the first through twentieth aspects, performing the one or more measurements to obtain the interference measurement information includes performing the one or more measurements during one or more first time occasions, and where obtaining the predicted interference information includes obtaining one or more predicted interference values for one or more second time occasions, where the one or more second time occasions are after the one or more first time occasions.

In a twenty-second aspect, alone or in combination with one or more of the first through twenty-first aspects, the configuration information indicates the one or more second time occasions.

In a twenty-third aspect, alone or in combination with one or more of the first through twenty-second aspects, performing the one or more measurements to obtain the interference measurement information includes performing the one or more measurements via one or more first frequency resources, and where obtaining the predicted interference information includes obtaining one or more predicted interference values for one or more second frequency resources, where the one or more second frequency resources are different than the one or more first frequency resources.

In a twenty-fourth aspect, alone or in combination with one or more of the first through twenty-third aspects, the predicted interference information indicates at least one of a predicted interference power, a predicted interference covariance matrix, or a predicted signal-to-interference-plus-noise ratio.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network entity or an apparatus of a network entity. Example process 1200 is an example where the apparatus or the network entity (e.g., the first network entity 705) performs operations associated with predicted interference reporting.

As shown in FIG. 12, in some aspects, process 1200 may include transmitting configuration information that indicates a first set of one or more serving resources for measurement and a second set of one or more serving resources for prediction, where the first set of one or more serving resources is associated with a third set of one or more interference resources for measurement, and where the second set of one or more serving resources is associated with a fourth set of one or more interference resources for prediction (block 1210). For example, the network entity (e.g., using transmission component 1404 or communication manager 1406, depicted in FIG. 14) may transmit configuration information that indicates a first set of one or more serving resources for measurement and a second set of one or more serving resources for prediction, where the first set of one or more serving resources is associated with a third set of one or more interference resources for measurement, and where the second set of one or more serving resources is associated with a fourth set of one or more interference resources for prediction, as described above.

As further shown in FIG. 12, in some aspects, process 1200 may include receiving a measurement report that indicates predicted interference information, where the interference measurement information is associated with the first set of one or more serving resources and the third set of one or more interference resources, where the predicted interference information is associated with the second set of one or more serving resources and the fourth set of one or more interference resources, and where the predicted interference information is based on the interference measurement information (block 1220). For example, the network entity (e.g., using reception component 1402 or communication manager 1406, depicted in FIG. 14) may receive a measurement report that indicates predicted interference information, where the interference measurement information is associated with the first set of one or more serving resources and the third set of one or more interference resources, where the predicted interference information is associated with the second set of one or more serving resources and the fourth set of one or more interference resources, and where the predicted interference information is based on the interference measurement information, as described above.

Process 1200 may include additional aspects, such as any single aspect or any combination of aspects described below or in connection with one or more other processes described elsewhere herein.

In a first aspect, the first set of one or more serving resources and the second set of one or more serving resources are a same set of one or more serving resources.

In a second aspect, alone or in combination with the first aspect, the third set of one or more interference resources includes one or more first interference resources, and where the fourth set of one or more interference resources includes one or more second interference resources.

In a third aspect, alone or in combination with one or more of the first and second aspects, the one or more first interference resources are different than the one or more second interference resources.

In a fourth aspect, alone or in combination with one or more of the first through third aspects, the third set of one or more interference resources is a subset of the fourth set of one or more interference resources.

In a fifth aspect, alone or in combination with one or more of the first through fourth aspects, the third set of one or more interference resources and the fourth set of one or more interference resources are a same set of one or more interference resources.

In a sixth aspect, alone or in combination with one or more of the first through fifth aspects, the first set of one or more serving resources includes one or more first serving resources, and where the second set of one or more serving resources includes one or more second serving resources.

In a seventh aspect, alone or in combination with one or more of the first through sixth aspects, the one or more first serving resources are different than the one or more second serving resources.

In an eighth aspect, alone or in combination with one or more of the first through seventh aspects, the first set of one or more serving resources is a subset of the second set of one or more serving resources.

In a ninth aspect, alone or in combination with one or more of the first through eighth aspects, the first set of one or more serving resources is a subset of the second set of one or more serving resources, and where the third set of one or more interference resources is a subset of the fourth set of one or more interference resources.

In a tenth aspect, alone or in combination with one or more of the first through ninth aspects, each serving resource included in the first set of one or more serving resources is associated with one or more respective interference resources included in the third set of one or more interference resources, and where each serving resource included in the second set of one or more serving resources is associated with one or more respective interference resources included in the fourth set of one or more interference resources.

In an eleventh aspect, alone or in combination with one or more of the first through tenth aspects, the first set of one or more serving resources is different than the second set of one or more serving resources, and where the third set of one or more interference resources is different than the fourth set of one or more interference resources.

In a twelfth aspect, alone or in combination with one or more of the first through eleventh aspects, the first set of one or more serving resources and the third set of one or more interference resources are associated with a first type of resource, and where the second set of one or more serving resources and the fourth set of one or more interference resources are associated with a second type of resource.

In a thirteenth aspect, alone or in combination with one or more of the first through twelfth aspects, the first type of resource is a synchronization signal block resource, and where the second type of resource is a channel state information reference signal resource.

In a fourteenth aspect, alone or in combination with one or more of the first through thirteenth aspects, the configuration information includes CSI configuration information.

In a fifteenth aspect, alone or in combination with one or more of the first through fourteenth aspects, the CSI configuration information includes one or more first flags that indicate that the first set of one or more serving resources and the third set of one or more interference resources are for measurement, and where the CSI configuration information includes one or more second flags that indicate that the second set of one or more serving resources and the fourth set of one or more interference resources are for prediction.

In a sixteenth aspect, alone or in combination with one or more of the first through fifteenth aspects, the CSI configuration information indicates that a resource, from the second set of one or more serving resources or the fourth set of one or more interference resources, is a non-zero-power resource, where the CSI configuration information indicates one or more transmission parameters for the non-zero-power resource, and where the predicted interference information is based on the one or more transmission parameters.

In a seventeenth aspect, alone or in combination with one or more of the first through sixteenth aspects, the configuration information includes CSI report configuration information, and where the CSI report configuration information indicates that the measurement report is a predicted interference report.

In an eighteenth aspect, alone or in combination with one or more of the first through seventeenth aspects, the CSI report configuration information indicates that the measurement report is a predicted MU-MIMO interference report.

In a nineteenth aspect, alone or in combination with one or more of the first through eighteenth aspects, the CSI report configuration information indicates that the measurement report is the predicted MU-MIMO interference report based on at least one resource from the second set or the fourth set being configured as a non-zero-power resource.

In a twentieth aspect, alone or in combination with one or more of the first through nineteenth aspects, the CSI report configuration information indicates that the measurement report is a predicted inter-cell interference measurement report.

In a twenty-first aspect, alone or in combination with one or more of the first through twentieth aspects, the interference measurement information is associated with one or more first time occasions, and where the predicted interference information is associated with one or more second time occasions, where the one or more second time occasions are after the one or more first time occasions.

In a twenty-second aspect, alone or in combination with one or more of the first through twenty-first aspects, the configuration information indicates the one or more second time occasions.

In a twenty-third aspect, alone or in combination with one or more of the first through twenty-second aspects, the interference measurement information is associated with one or more first frequency resources, and where the predicted interference information is associated with one or more second frequency resources, where the one or more second frequency resources are different than the one or more first frequency resources.

In a twenty-fourth aspect, alone or in combination with one or more of the first through twenty-third aspects, the predicted interference information indicates at least one of a predicted interference power, a predicted interference covariance matrix, or a predicted signal-to-interference-plus-noise ratio.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a network entity, or a network entity may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 114, the communication manager 118, or the communication manager 250. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 110, the processing system 112, or the processing system 240).

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11, or a combination thereof. In some aspects, the apparatus 1300 or one or more components shown in FIG. 13 may include one or more components described in connection with FIGS. 1-2. Additionally, or alternatively, one or more components shown in FIG. 13 may be implemented within one or more components described in connection with FIGS. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components described above in connection with FIGS. 1-2, such as a radio, one or more RF chains, one or more transceivers, or one or more modems, each of which may in turn be coupled with one or more antennas.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components described above in connection with FIGS. 1-2, such as a radio, one or more RF chains, one or more transceivers, or one or more modems, each of which may in turn be coupled with one or more antennas described in connection with FIGS. 1-2. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive configuration information that indicates a first set of one or more serving resources for measurement and a second set of one or more serving resources for prediction, where the first set of one or more serving resources is associated with a third set of one or more interference resources for measurement, and where the second set of one or more serving resources is associated with a fourth set of one or more interference resources for prediction. The communication manager 1306 may perform, based on the first set of one or more serving resources, one or more measurements to obtain interference measurement information associated with the third set of one or more interference resources. The reception component 1302 may obtain, based on the second set of one or more serving resources and the interference measurement information, predicted interference information associated with the fourth set of one or more interference resources. The transmission component 1304 may transmit a measurement report that indicates the predicted interference information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network entity, or a network entity may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 114, the communication manager 118, or the communication manager 255. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 110, the processing system 112, or the processing system 245).

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12, or a combination thereof. In some aspects, the apparatus 1400 or one or more components shown in FIG. 14 may include one or more components described in connection with FIGS. 1-2. Additionally, or alternatively, one or more components shown in FIG. 14 may be implemented within one or more components described in connection with FIGS. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components described above in connection with FIGS. 1-2, such as a radio, one or more RF chains, one or more transceivers, or one or more modems, each of which may in turn be coupled with one or more antennas of the network entity.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components described above in connection with FIGS. 1-2, such as a radio, one or more RF chains, one or more transceivers, or one or more modems, each of which may in turn be coupled with one or more antennas described in connection with FIGS. 1-2. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit configuration information that indicates a first set of one or more serving resources for measurement and a second set of one or more serving resources for prediction, where the first set of one or more serving resources is associated with a third set of one or more interference resources for measurement, and where the second set of one or more serving resources is associated with a fourth set of one or more interference resources for prediction. The reception component 1402 may receive a measurement report that indicates predicted interference information, where the interference measurement information is associated with the first set of one or more serving resources and the third set of one or more interference resources, where the predicted interference information is associated with the second set of one or more serving resources and the fourth set of one or more interference resources, and where the predicted interference information is based on the interference measurement information.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a network entity, comprising: receiving configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; performing, based on the first set of one or more serving resources, one or more measurements to obtain interference measurement information associated with the third set of one or more interference resources; obtaining, based on the second set of one or more serving resources and the interference measurement information, predicted interference information associated with the fourth set of one or more interference resources; and transmitting a measurement report that indicates the predicted interference information.

Aspect 2: The method of Aspect 1, wherein the first set of one or more serving resources and the second set of one or more serving resources are a same set of one or more serving resources.

Aspect 3: The method of Aspect 2, wherein the third set of one or more interference resources includes one or more first interference resources, and wherein the fourth set of one or more interference resources includes one or more second interference resources.

Aspect 4: The method of Aspect 3, wherein the one or more first interference resources are different than the one or more second interference resources.

Aspect 5: The method of any of Aspects 2-4, wherein the third set of one or more interference resources is a subset of the fourth set of one or more interference resources.

Aspect 6: The method of any of Aspects 1-5, wherein the third set of one or more interference resources and the fourth set of one or more interference resources are a same set of one or more interference resources.

Aspect 7: The method of Aspect 6, wherein the first set of one or more serving resources includes one or more first serving resources, and wherein the second set of one or more serving resources includes one or more second serving resources.

Aspect 8: The method of Aspect 7, wherein the one or more first serving resources are different than the one or more second serving resources.

Aspect 9: The method of any of Aspects 6-8, wherein the first set of one or more serving resources is a subset of the second set of one or more serving resources.

Aspect 10: The method of any of Aspects 1-9, wherein the first set of one or more serving resources is a subset of the second set of one or more serving resources, and wherein the third set of one or more interference resources is a subset of the fourth set of one or more interference resources.

Aspect 11: The method of any of Aspects 1-10, wherein each serving resource included in the first set of one or more serving resources is associated with one or more respective interference resources included in the third set of one or more interference resources, and wherein each serving resource included in the second set of one or more serving resources is associated with one or more respective interference resources included in the fourth set of one or more interference resources.

Aspect 12: The method of any of Aspects 1-11, wherein the first set of one or more serving resources is different than the second set of one or more serving resources, and wherein the third set of one or more interference resources is different than the fourth set of one or more interference resources.

Aspect 13: The method of any of Aspects 1-12, wherein the first set of one or more serving resources and the third set of one or more interference resources are associated with a first type of resource, and wherein the second set of one or more serving resources and the fourth set of one or more interference resources are associated with a second type of resource.

Aspect 14: The method of Aspect 13, wherein the first type of resource is a synchronization signal block resource, and wherein the second type of resource is a channel state information reference signal resource.

Aspect 15: The method of any of Aspects 1-14, wherein the configuration information includes channel state information (CSI) configuration information.

Aspect 16: The method of Aspect 15, wherein the CSI configuration information includes one or more first flags that indicate that the first set of one or more serving resources and the third set of one or more interference resources are for measurement, and wherein the CSI configuration information includes one or more second flags that indicate that the second set of one or more serving resources and the fourth set of one or more interference resources are for prediction.

Aspect 17: The method of any of Aspects 15-16, wherein the CSI configuration information indicates that a resource, from the second set of one or more serving resources or the fourth set of one or more interference resources, is a non-zero-power resource, wherein the CSI configuration information indicates one or more transmission parameters for the non-zero-power resource, and wherein obtaining the predicted interference information comprises: obtaining one or more predicted interference values associated with the non-zero power resource, wherein the one or more predicted interference values are based on the one or more transmission parameters.

Aspect 18: The method of any of Aspects 1-17, wherein the configuration information includes channel state information (CSI) report configuration information, and wherein the CSI report configuration information indicates that the measurement report is a predicted interference report.

Aspect 19: The method of Aspect 18, wherein the CSI report configuration information indicates that the measurement report is a predicted multi-user multiple-input multiple-output (MU-MIMO) interference report.

Aspect 20: The method of any of Aspects 18-19, wherein the CSI report configuration information indicates that the measurement report is the predicted MU-MIMO interference report based on at least one resource from the second set or the fourth set being configured as a non-zero-power resource.

Aspect 21: The method of Aspect 18, wherein the CSI report configuration information indicates that the measurement report is a predicted inter-cell interference measurement report.

Aspect 22: The method of any of Aspects 1-21, wherein performing the one or more measurements to obtain the interference measurement information comprises performing the one or more measurements during one or more first time occasions; and wherein obtaining the predicted interference information comprises: obtaining one or more predicted interference values for one or more second time occasions, wherein the one or more second time occasions are after the one or more first time occasions.

Aspect 23: The method of Aspect 22, wherein the configuration information indicates the one or more second time occasions.

Aspect 24: The method of any of Aspects 1-23, wherein performing the one or more measurements to obtain the interference measurement information comprises performing the one or more measurements via one or more first frequency resources; and wherein obtaining the predicted interference information comprises: obtaining one or more predicted interference values for one or more second frequency resources, wherein the one or more second frequency resources are different than the one or more first frequency resources.

Aspect 25: The method of any of Aspects 1-24, wherein the predicted interference information indicates at least one of: a predicted interference power, a predicted interference covariance matrix, or a predicted signal-to-interference-plus-noise ratio.

Aspect 26: A method of wireless communication performed by a network entity, comprising: transmitting configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; and receiving a measurement report that indicates predicted interference information, wherein the interference measurement information is associated with the first set of one or more serving resources and the third set of one or more interference resources, wherein the predicted interference information is associated with the second set of one or more serving resources and the fourth set of one or more interference resources, and wherein the predicted interference information is based on the interference measurement information.

Aspect 27: The method of Aspect 26, wherein the first set of one or more serving resources and the second set of one or more serving resources are a same set of one or more serving resources.

Aspect 28: The method of Aspect 27, wherein the third set of one or more interference resources includes one or more first interference resources, and wherein the fourth set of one or more interference resources includes one or more second interference resources.

Aspect 29: The method of Aspect 28, wherein the one or more first interference resources are different than the one or more second interference resources.

Aspect 30: The method of any of Aspects 27-29, wherein the third set of one or more interference resources is a subset of the fourth set of one or more interference resources.

Aspect 31: The method of any of Aspects 26-30, wherein the third set of one or more interference resources and the fourth set of one or more interference resources are a same set of one or more interference resources.

Aspect 32: The method of Aspect 31, wherein the first set of one or more serving resources includes one or more first serving resources, and wherein the second set of one or more serving resources includes one or more second serving resources.

Aspect 33: The method of Aspect 32, wherein the one or more first serving resources are different than the one or more second serving resources.

Aspect 34: The method of any of Aspects 31-33, wherein the first set of one or more serving resources is a subset of the second set of one or more serving resources.

Aspect 35: The method of any of Aspects 26-34, wherein the first set of one or more serving resources is a subset of the second set of one or more serving resources, and wherein the third set of one or more interference resources is a subset of the fourth set of one or more interference resources.

Aspect 36: The method of any of Aspects 26-35, wherein each serving resource included in the first set of one or more serving resources is associated with one or more respective interference resources included in the third set of one or more interference resources, and wherein each serving resource included in the second set of one or more serving resources is associated with one or more respective interference resources included in the fourth set of one or more interference resources.

Aspect 37: The method of any of Aspects 26-36, wherein the first set of one or more serving resources is different than the second set of one or more serving resources, and wherein the third set of one or more interference resources is different than the fourth set of one or more interference resources.

Aspect 38: The method of any of Aspects 26-37, wherein the first set of one or more serving resources and the third set of one or more interference resources are associated with a first type of resource, and wherein the second set of one or more serving resources and the fourth set of one or more interference resources are associated with a second type of resource.

Aspect 39: The method of Aspect 38, wherein the first type of resource is a synchronization signal block resource, and wherein the second type of resource is a channel state information reference signal resource.

Aspect 40: The method of any of Aspects 26-39, wherein the configuration information includes channel state information (CSI) configuration information.

Aspect 41: The method of Aspect 40, wherein the CSI configuration information includes one or more first flags that indicate that the first set of one or more serving resources and the third set of one or more interference resources are for measurement, and wherein the CSI configuration information includes one or more second flags that indicate that the second set of one or more serving resources and the fourth set of one or more interference resources are for prediction.

Aspect 42: The method of any of Aspects 40-41, wherein the CSI configuration information indicates that a resource, from the second set of one or more serving resources or the fourth set of one or more interference resources, is a non-zero-power resource, wherein the CSI configuration information indicates one or more transmission parameters for the non-zero-power resource, and wherein the predicted interference information is based on the one or more transmission parameters.

Aspect 43: The method of any of Aspects 26-42, wherein the configuration information includes channel state information (CSI) report configuration information, and wherein the CSI report configuration information indicates that the measurement report is a predicted interference report.

Aspect 44: The method of Aspect 43, wherein the CSI report configuration information indicates that the measurement report is a predicted multi-user multiple-input multiple-output (MU-MIMO) interference report.

Aspect 45: The method of any of Aspects 43-44, wherein the CSI report configuration information indicates that the measurement report is the predicted MU-MIMO interference report based on at least one resource from the second set or the fourth set being configured as a non-zero-power resource.

Aspect 46: The method of Aspect 43, wherein the CSI report configuration information indicates that the measurement report is a predicted inter-cell interference measurement report.

Aspect 47: The method of any of Aspects 26-46, wherein the interference measurement information is associated with one or more first time occasions, and wherein the predicted interference information is associated with one or more second time occasions, wherein the one or more second time occasions are after the one or more first time occasions.

Aspect 48: The method of Aspect 47, wherein the configuration information indicates the one or more second time occasions.

Aspect 49: The method of any of Aspects 26-48, wherein the interference measurement information is associated with one or more first frequency resources, and wherein the predicted interference information is associated with one or more second frequency resources, wherein the one or more second frequency resources are different than the one or more first frequency resources.

Aspect 50: The method of any of Aspects 26-49, wherein the predicted interference information indicates at least one of: a predicted interference power, a predicted interference covariance matrix, or a predicted signal-to-interference-plus-noise ratio.

Aspect 51: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-50.

Aspect 52: An apparatus for wireless communication at a device, the apparatus comprising one or more memories and one or more processors coupled to the one or more memories, the one or more processors configured to cause the device to perform the method of one or more of Aspects 1-50.

Aspect 53: An apparatus for wireless communication, the apparatus comprising at least one means for performing the method of one or more of Aspects 1-50.

Aspect 54: A non-transitory computer-readable medium storing code for wireless communication, the code comprising instructions executable by one or more processors to perform the method of one or more of Aspects 1-50.

Aspect 55: A non-transitory computer-readable medium storing a set of instructions for wireless communication, the set of instructions comprising one or more instructions that, when executed by one or more processors of a device, cause the device to perform the method of one or more of Aspects 1-50.

Aspect 56: A device for wireless communication, the device comprising a processing system that includes one or more processors and one or more memories coupled with the one or more processors, the processing system configured to cause the device to perform the method of one or more of Aspects 1-50.

Aspect 57: An apparatus for wireless communication at a device, the apparatus comprising one or more memories and one or more processors coupled to the one or more memories, the one or more processors individually or collectively configured to cause the device to perform the method of one or more of Aspects 1-50.

Aspect 58: A device comprising a processing system that includes one or more processors and one or more code-storing memories coupled with the one or more processors, the processing system configured to cause the device to perform the method of one or more of Aspects 1-50.

Aspect 59: A device comprising a processing system that includes processor circuitry and code-storing memory circuitry, the processing system configured to cause the device to perform the method of one or more of Aspects 1-50.

Aspect 60: A device for wireless communication, the device comprising a processing system, the processing system configured to perform the method of one or more of Aspects 1-50.

Aspect 61: A non-transitory computer-readable medium having code thereon that, when executed by a device, causes the device to perform the method of one or more of Aspects 1-50.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples.

In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network entity, comprising:
a processing system, configured to:
receive configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction;
perform, based on the first set of one or more serving resources, one or more measurements to obtain interference measurement information associated with the third set of one or more interference resources;
obtain, based on the second set of one or more serving resources and the interference measurement information, predicted interference information associated with the fourth set of one or more interference resources; and
transmit a measurement report that indicates the predicted interference information.

2. The network entity of claim 1, wherein the first set of one or more serving resources and the second set of one or more serving resources are a same set of one or more serving resources.

3. The network entity of claim 2, wherein the third set of one or more interference resources includes one or more first interference resources, and wherein the fourth set of one or more interference resources includes one or more second interference resources.

4. The network entity of claim 3, wherein the one or more first interference resources are different than the one or more second interference resources.

5. The network entity of claim 2, wherein the third set of one or more interference resources is a subset of the fourth set of one or more interference resources.

6. The network entity of claim 1, wherein the third set of one or more interference resources and the fourth set of one or more interference resources are a same set of one or more interference resources.

7. The network entity of claim 6, wherein the first set of one or more serving resources includes one or more first serving resources, and wherein the second set of one or more serving resources includes one or more second serving resources.

8. The network entity of claim 7, wherein the one or more first serving resources are different than the one or more second serving resources.

9. The network entity of claim 6, wherein the first set of one or more serving resources is a subset of the second set of one or more serving resources.

10. The network entity of claim 1, wherein the first set of one or more serving resources is a subset of the second set of one or more serving resources, and wherein the third set of one or more interference resources is a subset of the fourth set of one or more interference resources.

11. The network entity of claim 1, wherein each serving resource included in the first set of one or more serving resources is associated with one or more respective interference resources included in the third set of one or more interference resources, and wherein each serving resource included in the second set of one or more serving resources is associated with one or more respective interference resources included in the fourth set of one or more interference resources.

12. The network entity of claim 1, wherein the first set of one or more serving resources is different than the second set of one or more serving resources, and wherein the third set of one or more interference resources is different than the fourth set of one or more interference resources.

13. The network entity of claim 1, wherein the first set of one or more serving resources and the third set of one or more interference resources are associated with a first type of resource, and wherein the second set of one or more serving resources and the fourth set of one or more interference resources are associated with a second type of resource.

14. The network entity of claim 1, wherein the configuration information includes channel state information (CSI) configuration information.

15. The network entity of claim 14, wherein the CSI configuration information includes one or more first flags that indicate that the first set of one or more serving resources and the third set of one or more interference resources are for measurement, and wherein the CSI configuration information includes one or more second flags that indicate that the second set of one or more serving resources and the fourth set of one or more interference resources are for prediction.

16. The network entity of claim 14, wherein the CSI configuration information indicates that a resource, from the second set of one or more serving resources or the fourth set of one or more interference resources, is a non-zero-power resource, wherein the CSI configuration information indicates one or more transmission parameters for the non-zero-power resource, and wherein, to obtain the predicted interference information, the processing system is configured to:
obtain one or more predicted interference values associated with the non-zero power resource, wherein the one or more predicted interference values are based on the one or more transmission parameters.

17. The network entity of claim 1, wherein the configuration information includes channel state information (CSI) report configuration information, and wherein the CSI report configuration information indicates that the measurement report is a predicted interference report.

18. The network entity of claim 17, wherein the CSI report configuration information indicates that the measurement report is a predicted multi-user multiple-input multiple-output (MU-MIMO) interference report.

19. The network entity of claim 18, wherein the CSI report configuration information indicates that the measurement report is the predicted MU-MIMO interference report based on at least one resource from the second set or the fourth set being configured as a non-zero-power resource.

20. The network entity of claim 1, wherein, to perform the one or more measurements to obtain the interference measurement information, the processing system is configured to perform the one or more measurements during one or more first time occasions; and
wherein, to obtain the predicted interference information, the processing system is configured to:
obtain one or more predicted interference values for one or more second time occasions, wherein the one or more second time occasions are after the one or more first time occasions.

21. The network entity of claim 1, wherein, to perform the one or more measurements to obtain the interference measurement information, the processing system is configured to perform the one or more measurements via one or more first frequency resources; and
wherein, to obtain the predicted interference information, the processing system is configured to:
obtain one or more predicted interference values for one or more second frequency resources, wherein the one or more second frequency resources are different than the one or more first frequency resources.

22. A network entity, comprising:
a processing system, configured to:
transmit configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction; and
receive a measurement report that indicates predicted interference information that is based on interference measurement information, wherein the interference measurement information is associated with the first set of one or more serving resources and the third set of one or more interference resources, wherein the predicted interference information is associated with the second set of one or more serving resources and the fourth set of one or more interference resources.

23. The network entity of claim 22, wherein each serving resource included in the first set of one or more serving resources is associated with one or more respective interference resources included in the third set of one or more interference resources, and wherein each serving resource included in the second set of one or more serving resources is associated with one or more respective interference resources included in the fourth set of one or more interference resources.

24. The network entity of claim 22, wherein the first set of one or more serving resources and the third set of one or more interference resources are associated with a first type of resource, and wherein the second set of one or more serving resources and the fourth set of one or more interference resources are associated with a second type of resource.

25. The network entity of claim 22, wherein the configuration information includes channel state information (CSI) configuration information, wherein the CSI configuration information includes one or more first flags that indicate that the first set of one or more serving resources and the third set of one or more interference resources are for measurement, and wherein the CSI configuration information includes one or more second flags that indicate that the second set of one or more serving resources and the fourth set of one or more interference resources are for prediction.

26. The network entity of claim 22, wherein the configuration information includes channel state information (CSI) report configuration information, and wherein the CSI report configuration information indicates that the measurement report is a predicted interference report.

27. A method of wireless communication performed by a network entity, comprising:
receiving configuration information that indicates a first set of one or more serving resources for measurement and a second set of one or more serving resources for prediction, wherein the first set of one or more serving resources is associated with a third set of one or more interference resources for measurement, and wherein the second set of one or more serving resources is associated with a fourth set of one or more interference resources for prediction;
performing, based on the first set of one or more serving resources, one or more measurements to obtain interference measurement information associated with the third set of one or more interference resources;
obtaining, based on the second set of one or more serving resources and the interference measurement information, predicted interference information associated with the fourth set of one or more interference resources; and
transmitting a measurement report that indicates the predicted interference information.

28. The method of claim 27, wherein the first set of one or more serving resources and the second set of one or more serving resources are a same set of one or more serving resources.

29. The method of claim 27, wherein the third set of one or more interference resources is a subset of the fourth set of one or more interference resources.

30. The method of claim 27, wherein the first set of one or more serving resources is a subset of the second set of one or more serving resources, and wherein the third set of one or more interference resources is a subset of the fourth set of one or more interference resources.
